(19) United States
(12) Patent Application Publication
(10) Pub. No.: US 2011/0307548 A1
(43) Pub. Date: Dec. 15, 2011

(54) DATA DISTRIBUTION

(75) Inventors: Julian Basil FISK, Cambridge (GB); Kaushik Kotak, Cambridge (GB); Adam Jarvis Garston, Cambridge (GB); Ian Laurence Jamieson, Cambridge (GB); Terry Alan Austin, Berks (GB); Colin Donald Plimmer, Herts (GB); Julia Christine Ann Page, Sandy (GB)

(73) Assignee: QUADRIGA TECHNOLOGY LIMITED, London (GB)

(21) Appl. No.: 13/164,277

(22) Filed: Jun. 20, 2011

Related U.S. Application Data
(63) Continuation of application No. 10/475,102, filed on May 4, 2004.

(30) Foreign Application Priority Data
Apr. 17, 2001 (GB) 0109409.3
Nov. 2, 2001 (GB) 0126398.7
Nov. 13, 2001 (GB) 0127249.1
Feb. 11, 2002 (GB) PCT/GB02/00596

(51) Int. Cl. G06F 15/16

(52) U.S. Cl. 709/203

(57) ABSTRACT

A data distribution system is presented. A remote server, such as a Hub Server is connected to a local distribution sub-system including a local server, such as a Head End Server. Data is transmitted from a component of the local distribution sub-system, such as a Local Control Unit to the local server and the data is transmitted from the local server to the remote server.

The present invention relates among other things to the distribution and networking of television, video and other signals.

Conventional distribution systems employ a server and one or more receivers distributed on a network. Such systems distribute content directly to each receiver, and typically each receiver is controlled by a single user or is associated with a single primary output device. Such systems are suitable for large numbers of widely distributed users, but are not ideally suited to the distribution of content to clusters of users.

It is known to provide local servers to distribute content to such clusters of users, but the use of such local servers raises a number of difficulties in maintaining control of and communication between such local servers, and in providing the appropriate service for each user of the system regardless of which local server they receive content from.

Such difficulties are exacerbated if it is desired to distribute a range of different types of data, if users are transient, using different local servers at different times, if it is desired to maintain centralised control of the system, if it is desired to bill users directly for use of the system, if individual users have different needs or expectations of the system, and if it is desired to increase the level of interaction between individual users and the system.

The present invention seeks to ameliorate these problems, or at least to provide the public with a useful alternative.

It should be noted that certain aspects of this invention find particular application in a media distribution networking system for use in a multi-user or multi-room environment, or across a local network. Many of the embodiments as described herein (in any aspect or embodiment) are directed to systems within hotels and their installation and use. As used herein the term “hotel” is preferably to be understood as encompassing any form of establishment where guests are temporarily allocated a room or similar or part thereof, whether for payment or not. It should be understood that the embodiments, and the systems, methods and features, described herein are also readily installed and used within other environments, including, in particular ships, particularly cruise ships, aeroplanes, trains, hospitals, multi-dwelling units, for instance blocks of fiats, or condominiums, groups of houses, offices or groups of offices, factories, shops or groups of shops, schools and other work, commercial or educational environments, stations, airports and other transport termini.

### Double Back Channel

According to one aspect of the invention, there is provided a method of managing a data distribution system comprising a remote server and a local distribution sub-system including a local server, comprising transmitting data from a component of the local distribution sub-system to the local server; and transmitting the data from the local server to the remote server.

In this way increased control over the management of the data distribution system may be provided.

In one embodiment of the invention, the component of the local distribution sub-system may be a component of the server itself.

The method may further comprise processing the data at the local server before transmission to the remote server. The method may thus provide increased functionality.

Preferably, this processing step may include associating the data with time, date, or other unique identification. Instead, or in addition, this processing step may involve a sophisticated analysis of the data, for example, a statistical analysis of the data transmitted from the component of the local distribution sub-system.

The method may further comprise transmitting further data from the remote server to the local server, and preferably distributing the further data within the local distribution sub-system.

Preferably, the method comprises receiving the data at the remote server and transmitting the further data in response to the data.

Preferably, the method may further comprise storing the data at the local server prior to transmission to the remote server, preferably in a database.

More preferably, the method may further comprise storing the data at the remote server, also preferably in a database.

Preferably, the method may further comprise generating priority data representing the importance of respective data.

More preferably, the method may further comprise transmitting data to the remote server in dependence upon such priority data.

The method may comprise transmitting data to the remote server periodically.

In a preferred embodiment, the method may comprise providing a plurality of local distribution sub-systems each including a respective local server; transmitting respective data from a respective component of each local distribution sub-system to a respective local server; and transmitting the respective data from each such local server to the remote server

Preferably, the method may comprise transmitting data from a plurality of components of the or each local distribution system.

### Diagnostic Information

The method may further comprise receiving the data at the remote server and analysing performance of the system in dependence upon the data.

In this way increased efficiency of the system may be provided.

According to another aspect of the invention, there is provided a method of analysing the performance of a data distribution system comprising a remote sewer and a local distribution sub-system, comprising receiving at the remote server data from a component of the local sub-system; and analysing the performance of the data distribution system in dependence upon this data.

Preferably, the data comprises data from a pre-determined number of users and/or recorded over a pre-determined period of time and/or received from a pre-determined local server.

The data may comprise diagnostic data.

Instead or in addition, the data may comprise status information.

The method may further comprise debugging an error in dependence upon the data.

### Recording Keystrokes

The data may comprise user input data.

Preferably, the data comprises a user identifier.

More preferably, the method comprises generating or updating a user profile in dependence upon the user input data.

### User Profile

According to a further aspect of the invention, there is provided, a method of generating a user profile, comprising transmitting user input data from a component of a local distribution sub-system to a remote sewer; and generating the user profile in dependence upon this user input data.

The method may further comprise, generating the user profile in dependence upon user input data obtained from a further component of the local distribution sub-system and/or from a component of a further local distribution sub-system, remote from the local distribution sub-system.

Preferably, the method comprises generating the user profile in dependence upon an existing profile.

According to yet another aspect of the invention, there is provided a method of managing distribution of data, comprising providing a local distribution sub-system including a local server; and transferring a user profile from a remote server to the local server.

Preferably, the method may comprise transferring the user profile in response to a transfer request, preferably transmitted from the local server to the remote server.

More preferably, the transfer request may comprise a user identifier. The method may further comprise storing the user profile at the local distribution sub-system.

The method may further comprise deleting the user profile stored at the local distribution system in dependence upon the expiry of a pre-determined time period and/or in dependence upon user input data.

Preferably, the method may comprise generating at the local server data in dependence upon the user profile.

More preferably, a menu of data may be generated.

Also, preferably, display data may be generated.

The method may further comprise transmitting the data from the local server to a component of the local distribution sub-system.

Preferably, the method may also comprise receiving a request for data and transmitting the data to the component of the local distribution sub-system in response to such request.

Preferably, the request for data comprises a user identifier.

The method may comprise selecting a user profile in dependence upon the user identifier, and generating the data in dependence upon the selected user profile.

In another aspect, the invention provides, a method of managing the distribution of data, comprising providing a local distribution system including a local server, storing a plurality of user profiles at the local server; receiving a request; selecting a user profile in dependence upon the request; generating data in dependence upon the selected user profile; and transmitting the data to a component of the local distribution system.

Preferably, the request may comprise a user identifier and/or an identifier which identifies the component of the local distribution system.

Preferably, the user profile may be in the form of a user profile generated as herein before described.

### Recording Keystrokes

A further aspect of the invention is now described in which there is provided a system for storing data, comprising a server serving a plurality of users, means for receiving data from a user, means for transmitting such data to the server, and a memory for storing such data.

By providing a memory at a server serving a plurality of users for recording data, a record of user actions, as well as other system events may be maintained.

The system may be any type of storage system, such as a telecommunications system, a computer system, or a video or audio transmission system. In particular the system may be a video and/or audio and/or computer entertainment system installed in a multiple dwelling or multiple room building or buildings, for instance a hotel.

The data may be stored for a given length of time, such as a day, a week or a month.

The means for transmitting such data (typically in the form of a transmission channel) or from the receiving means to the server may preferably also be used to transmit data from the server. The transmission channel may comprise electrical cable, for instance co-axial cable, or twisted pair cable, for instance data grade twisted pair cable, such as twisted-pair cable that substantially complies with or exceeds the specification of ANSI/EIA/TIA-568-1991, Category 3, or complies with or exceeds the specification of Category 5, or telephone grade twisted pair cable, or may comprise an electromagnetic radiation transmission path, for instance a microwave link, or any combination of such cable or such transmission paths.

The receiving means may suitably comprise any kind of pressure, sound, light, temperature or motion sensitive device, for instance a button or switch, or a keypad, such as a remote control, keyboard or mouse. Such receiving means may typically be used to provide commands to control a device, such as a television or the like. Storage of data from the receiving means is typically incidental to the main function of the receiving means.

The receiving means may be linked to electrical or mechanical apparatus in a room, for instance a television, video recorder or player, lights, door or lock mechanisms, mini-bar systems, heating or air-conditioning systems, fire or smoke alarms, sprinkler systems, taps, or showers.

The memory is preferably located at the server, and may comprise any type of electronic data storage device, for instance a hard disc drive, floppy disc, CD, or optical storage device, or may comprise, or may be non-electronic, for instance, a print-out.

The data may include additional data relating to, for instance, the status of the system or the user of the system. For instance the data may include the date or time at which the data was generated or stored, or the status of the system, or any component of the system or any electrical or mechanical apparatus linked to the system, or an identifier relating to the user, such as the user's name, or the name of the user's employer, or an identifier relating to the system or any part thereof, or to any electrical or mechanical apparatus linked to the system. For instance the data may comprise error messages, so that debugging can occur, based for example on the user's previous actions.

Preferably, the system further comprises a hub server and at least one further server, the hub server serving the plurality of said servers, and means for transmitting said data to the hub.

In this way, the hub can analyse and/or compare data from different servers.

Preferably the system includes means for retrieving said data from the hub server. Preferably, the hub server is located at a site remote from said servers, and may include any type of electronic data storage device, for instance a hard disc drive, floppy disc, CD, or optical storage device.

Preferably, the system further comprises means for selecting data to be transmitted to the hub server from data stored in the storage means.

Preferably the system further comprises means for configuring the system in dependence upon the stored data. Hence, the stored data can be utilised to reflect the preferences of a user.

The configuring means is preferably adapted to configure the system either in dependence on data stored either at the server or at the hub, for greater speed and efficiency.

Preferably, the system further comprises means for receiving a user identifier, and associating/correlating the stored data with the user identifier.

Preferably, the or each server is adapted to receive a user identifier; retrieve stored data associated/correlated with the user identifier, and configure the system in dependence upon the retrieved data.

Preferably, the system further comprises means for debugging an error in the system in dependence upon the stored data.

Preferably, the system further comprises a processor for processing data stored in the memory. By providing a processor for processing data, information concerning, for instance, characteristics of the system, or components of the system, or of a user may be deduced or extracted.

The processor (typically at the server) may be any kind of electronic processing device, and may comprise for instance a dedicated hardware component, or a general purpose processor running an application.

The processor may process said data and perform any kind of statistical analysis on or between the data and preferably also on or between the data and external data. The processor may, for instance, provide averages, correlations, sensitivities, or time series analysis, or it may apply artificial intelligence or neural network or data mining routines to the data and/or external data. The processor may also apply any kind of data fitting or extrapolation techniques.

For instance, the processor may process said data and or external data to produce aggregated data for, for instance, a hotel as a whole, as a function of time or date, or of user characteristics, or of the types of audio, video or other data available to user's, or of hotel occupation rates, or user expenditure within the hotel, or of other aggregate or individual user characteristics.

Preferably, the processor processes the received data after it has been stored in the memory.

Preferably, the processor is adapted to process the data to generate analysis data, and associates/correlates the data with the analysis data.

Preferably, the analysis data is indicative of the time and/or date of receipt of the data.

Preferably, the processor performs a statistical analysis on the data.

Preferably, the or each server is adapted to receive data from a user in a hotel.

The processor may process said data for a particular user during one period of time, for instance during one hotel stay, or over a series of hotel stays.

Preferably, the system further comprises means for selecting data to be transmitted to the hub from data stored in the storage means.

A further aspect of the invention provides a method of storing data, using the system as described above.

### Diagnostic Information

In a further aspect of the invention there is provided a method of managing diagnostic information, the method comprising receiving diagnostic information from a plurality of devices; and forwarding the received diagnostic information to a remote server.

In a further aspect of the invention there is provided a method of installing software as described herein, wherein said software is installed in response to the receipt of the diagnostic information at the remote server.

In a further aspect of the invention there is provided a method of installing software as described herein, wherein said diagnostic information is indicative of whether said software has been installed successfully.

In a further aspect of the invention there is provided apparatus for managing diagnostic information, the apparatus comprising a local server configured to receive diagnostic information from a plurality of devices and forward the received diagnostic information to a remote server.

Preferably the apparatus further comprises a remote server for receiving said diagnostic information from said local server.

Preferably said remote server is configured to transmit software in response to receipt of said diagnostic information.

Preferably the local server is configured to receive and store audio/visual data and distribute the audio/visual data on demand to one or more of the devices.

Preferably, the apparatus further comprises one or more additional local servers, each additional local server being configured to receive diagnostic information from a respective plurality of devices and forward the received diagnostic information to the remote server.

Preferably the diagnostic information is in the form of SNMP traps or XML files.

Preferably said local server is configured to receive software from said remote server and install said software.

### XML/Distributing Data

According to another aspect of the invention, there is provided a method of distributing data, comprising receiving data and associated data at a first device; parsing the associated data; processing the data in dependence upon the parsing of the associated data; and transmitting the data from the first device to a second device.

The processing step may comprise storing the data. Instead, or in addition, the processing step may comprise passing the data to an appropriate processor for processing.

The data may include content, software upgrades, electronic programme guide data, data relating to the description of content, status information, error messages or other notification data, data related to usage information, or any other form of data, or a combination of the above forms of data.

Preferably, the method may comprise generating the associated data at a third device. More preferably, the method may comprise transmitting the data and the associated data from the third device to the first device.

Preferably, the method may further comprise transmitting further associated data from the first device to the second device; parsing the further associated data at the second device; and processing the data at the second device in dependence upon the parsing of the further associated data.

Also, preferably, the method may comprise generating the further associated data. More preferably, the method may comprise generating the further associated data at the first device.

Preferably, the first device and the second device are components of a local data distribution system.

According to another aspect of the invention, there is provided a method of managing the distribution of data comprising providing a local data distribution system; associating associated data with data at a component of a local distribution sub-system; transmitting the data and the associated data to a device; parsing the associated data; and processing the data in dependence upon the parsing of the associated data.

Preferably, the method may comprise generating the associated data.

Also, preferably, the device may be a further component of the local data distribution system. Instead, or in addition, the device may comprise a remote server.

The data may comprise a plurality of sets of data, and the associated data and/or the further associated data may define a relationship between at least two of the sets of data.

Preferably, the associated data and/or the further associated data may comprise a control command.

The data may comprise executable data.

Preferably, the method may comprise parsing the associated data and/or the further associated data using a set of rules.

More preferably, the set of rules may be a publically available set of rules.

In one embodiment, the set of rules may comprise an XML schema or XML document type definition.

### XML

In another aspect of the invention, there is provided a method of downloading data sets, comprising transmitting data sets along with a common header file for those data sets to a device.

Preferably the header file defines relationships between the data sets, and preferably the header file is written at least in part in the language “XML”, and the header file contains instructions for how the device is to process the data sets. Such processing may involve, for example distributing or updating.

In particular, the device may be located at a hotel.

Preferably the method further comprises storing the data sets, and distributing the data sets to a plurality of local control units.

In a further aspect of the invention there is provided apparatus for putting into effect a method as aforesaid.

In a further aspect of the invention there is provided a method of requesting data, comprising transmitting a request for data which comprises a description of characteristics of the data.

Preferably the request for data is written at least in part in a universal language, which can preferably encapsulate information of any kind, and is preferably written in the language “XML”.

Preferably the data is content or status information.

In a further aspect of the invention there is provided a method of manipulating data, the method comprising: downloading a file; determining the content of the file; selecting a content processor in accordance with the content of the file; and manipulating the file with the selected content processor.

Preferably the content of the file is determined from the file itself.

Preferably the file includes a file name, and the content of the file is determined from the file name.

Preferably the method further comprises downloading information identifying the content of a file to be subsequently transmitted, wherein the content of the file is determined from the downloaded information.

### Software Upgrades

According to yet a further aspect of the invention, there is provided a method of managing a data distribution system comprising a remote server and a local distribution sub-system including a local server, the method comprising transmitting software from the remote server to the local server, and installing the software in a device within the local sub-system.

The method may comprise transmitting the software telegraphically.

Preferably, the method may comprise installing the software automatically.

The method may further comprise transmitting associated data to the local server, and selecting and/or installing the software in dependence upon the associated data.

Preferably, the method further comprises transmitting the software to a component of the local sub-system and installing the software at the component.

In a further aspect of the invention there is provided a method of installing software, comprising transmitting software to a location from a remote location, and installing said software.

Another aspect of the invention provides a method of installing software at a hotel, comprising transmitting software to the hotel from a remote location and installing said software, thus enabling the installation of software with greater ease and economy.

The term “installing” as used herein includes “updating”. Typically the software is installed in a or in part of a hotel TV system.

Preferably, the method comprises transmitting the software telegraphically.

Preferably, the method further comprises providing a receiver for audio/visual data located in a hotel room, and installing the software in the receiver.

Preferably, the method further comprises providing a server for receiving and distributing audio/visual data in a hotel, and installing the software in the server.

This important feature is provided independently.

Therefore, according to a further aspect of the present invention, there is provided a method of installing software at a hotel, comprising providing a server for receiving and distributing audio/visual data in a hotel, and installing the software in the sewer.

Preferably, the method further comprises transmitting to the hotel information informing the hotel of the name and/or content of software to be subsequently transmitted to the hotel.

According to another aspect of the invention, there is provided a method of installing software, comprising transmitting software to a first device, transmitting the software thence to a second device, and installing said software in said second device.

Preferably, the method includes providing a third device intermediate the first and second devices.

Preferably the method further comprises transmitting to the first device information informing the first device of the name and/or content of software to be subsequently transmitted to the first device.

Preferably, the method further comprises identifying the software at the first device and analysing to which of a plurality of such second devices the software is to be transmitted.

Preferably the software comprises a set of computer instructions and/or content such as a media asset or user interface asset.

Preferably the software comprises source code, object code, an executable file or configuration information.

Preferably the software is a program update, the method further comprising the step of updating an installed program in accordance with the program update.

Preferably the program update includes schedule information, and the step of updating the installed program is performed at a time determined by the schedule information.

### Dynamic Generation of EPGs at Local Server

According to a further aspect of the invention, there is provided a method of managing a data distribution system comprising a remote server and a local sub-system including a local server, comprising transmitting data from the remote server to the local server; storing the data at the local server; and generating at the local server a menu of data available for distribution within the local sub-system.

The method may further comprise generating a plurality of menus at the local server. In addition, the method may also comprise generating a plurality of interlinked menus at the local server.

Preferably, the method may comprise generating the menu or menus in dependence upon a characteristic of the data.

The method may further comprise determining the characteristic of the data from descriptive data transmitted from the central server to the local server.

### Bookmarking

A further aspect of the invention is now described in which there is provided a method of transmitting a program to a receiver, the method comprising the steps of transmitting a portion of the program to the receiver during a transmit session, generating bookmark data, the bookmark data being indicative of the progress of the transmit session, and storing the bookmark data.

The stored bookmark data can then optionally be used to enable a user to review a second portion of the program during a second transmit session, the starting point of the second portion being determined, at least in part, by the stored bookmark data.

Preferably the method further comprises the step of transmitting a second portion of the program to the receiver during a second transmit session, the starting point of the second portion being determined, at least in part, by the stored bookmark data.

The starting point of the second portion may be determined absolutely by the stored bookmark data. Alternatively, the starting point of the second portion may be adjusted in response to user input. The first and second portions will in general be non-overlapping consecutive portions of the program, although conceivably the first and second portions may be partially overlapping.

Preferably the method further comprises the steps of receiving a resume request, checking the availability of playout resources in response to the receipt of the resume request, initiating the second transmit session if a playout resource is available, and transmitting a message to the receiver if a playout resource is not available.

Thus, the receiver can be notified if a playout resource is not available.

Preferably the method further comprises the steps of receiving a pause request, terminating the first transmit session in response to receipt of the pause request, and monitoring the expiry of a predetermined pause period following receipt of the pause request, wherein the bookmark data is generated in response to the expiry of the pause period.

This provides a pause functionality which enables an efficient use of playout resources. The bookmark data is generated and stored on expiry of the predetermined pause period.

Preferably the method further comprises the step of receiving the pause request from a user input device.

The user input device may be any suitable device, such as a keyboard, mouse or microphone (in combination with suitable voice recognition software).

Preferably the method further comprises the steps of transmitting a portion of a program to the receiver during a subsequent transmit session, receiving a stop request, terminating the transmit session in response to receipt of the stop request, generating subsequent bookmark data, the subsequent bookmark data being indicative of the progress of the subsequent transmit session, and storing the subsequent bookmark data.

Thus the method provides a stop function as well as a pause function.

Preferably the method further comprises allocating a playout resource to the receiver during the first transmit session, and de-allocating the playout resource from the receiver after termination of the first transmit session.

Thus, the playout resource can be freed up and promptly allocated to another receiver if required.

Typically the playout resource is an output channel of a playout computer.

Preferably the playout resource is de-allocated in response to expiry of the pause period.

Thus, the playout resource can remain allocated to the receiver during the pause period, enabling transmission to resume quickly if a resume command is received during the pause period.

Preferably the method further comprises the steps of receiving a service request, terminating the first transmit session in response to receipt of the service request, and transmitting data associated with the service request to the receiver.

This can provide a re-allocation of playout resources in the period following the first transmit session, thus enabling a more efficient use of playout resources, and providing a more comprehensive service to a user. The data associated with the service request may for instance be a different program (such as an MPEG2 stream), or some announcement or message such as a wakeup call.

Preferably the method further comprises the steps of comparing the received service request with previously stored prioritisation rules to determine a priority level of the received service request, and terminating the first transmit session only if the priority level exceeds a predetermined threshold.

Thus, the first transmit session will not be disrupted if a low priority service request is received.

Preferably the method further comprises the step of receiving the service request from a user input device.

The user input device may be any suitable device, such as a keyboard, mouse or microphone (in combination with suitable voice recognition software).

Preferably the method further comprises the steps of generating bookmark review information in accordance with the stored bookmark data, and presenting the bookmark review information to a user.

The bookmark review information may be identical to the stored bookmark data, it may contain only a subset of the stored bookmark data, and/or it may contain additional information. In a preferred example, the bookmark review information comprises a program title, and the amount of time remaining. The bookmark review information may be presented to the user in visual and/or or aural form, or in any other suitable way. A menu of items of bookmark review information (each associated with a different program) may be presented to the user, enabling the user to select a desired program.

Preferably the method further comprises the steps of receiving a bookmark review information amendment request, and amending the bookmark review information data in accordance with the bookmark review information amendment request.

This can enable a user to actively amend the bookmark review information, for instance by deleting the information. This may be desirable if the user is sure that he will not want to resume his review of the program at a later time, thus reducing the amount of information which needs to be presented to the user. Alternatively it may be desirable for the user to delete (or otherwise amend) the information if it relates to adult content which could cause embarrassment to the user.

The bookmark review information can be amended, if necessary, without amending the underlying stored bookmark data.

Preferably the method further comprises the step of receiving the bookmark review information amendment request from a user input device.

The user input device may be any suitable device, such as a keyboard, mouse or microphone (in combination with suitable voice recognition software).

Preferably the method further comprises the steps of receiving a bookmark amendment request, and amending the stored bookmark data in accordance with the bookmark amendment request.

Instead of amending the bookmark review information, the user can amend the underlying stored bookmark data, for instance by deleting the data. This can save on memory space as well as providing the same advantages discussed above in relation to amending the bookmark review information.

The receiver may be part of a local control unit have a transmission functionality which enables the bookmark amendment request and/or bookmark review information amendment request and/or service request to be received from the local control unit. Alternatively the request may be received from some other source.

Preferably the method further comprises the step of receiving the bookmark amendment request from a user input device.

The user input device may be any suitable device, such as a keyboard, mouse or microphone (in combination with suitable voice recognition software).

The method may be performed in any system, particularly any networked system, for distributing data as described herein, and may in particular be performed by a system for distributing television/video or television/video/radio/audio signals to different locations as described herein. The method may be performed by a server as described herein.

The method may be performed by, for instance, a processor or switch, which may be part of a large processor or server, or may be a stand alone device. The means for performing the invention may be implemented in hardware and or software.

The bookmark data may be stored in a memory, for instance a hard disc, floppy disc, or indeed any computer or electronic storage device, or may be printed out.

The program may be any type of electronic data, particularly digital data, for instance computer data, including computer programmes, text data, and or signals representative of audio/visual data, and may include data in a variety of compression formats, including MPEG-4, MP3 protected by different ciphering algorithms including DVB-CS, DES, 3DES. The program may be transmitted according to a variety of different protocols or techniques, in particular IP protocol. The program may, in particular, be television or video signals, particularly, but not exclusively, digital signals, and may be distributed in the form of a data stream, for instance an MPEG transport stream.

A further aspect of the invention is now described in which there is provided apparatus for transmitting a program to a receiver, the apparatus comprising a playout resource for transmitting a portion of the program to the receiver during a transmit session, means for generating bookmark data, the bookmark data being indicative of the progress of the transmit session, and a memory for storing the bookmark data.

Preferably the playout resource is adapted to transmit a second portion of the program to the receiver during a second transmit session, the starting point of the second portion being determined, at least in part, by the stored bookmark data.

Preferably the apparatus further comprises means for receiving a resume request, and means for checking the availability of playout resources in response to the receipt of the resume request, initiating the second transmit session if a playout resource is available, and transmitting a message to the receiver if a playout resource is not available.

Preferably the apparatus further comprises means for receiving a pause request, means for terminating the first transmit session in response to receipt of the pause request, and means for monitoring the expiry of a predetermined pause period following receipt of the pause request, wherein the bookmark data is generated in response to the expiry of the pause period.

Preferably the apparatus further comprises a user input device for receiving and transmitting the pause request.

The user input device may be any suitable device, such as a keyboard, mouse or microphone (in combination with suitable voice recognition software).

Preferably the transmitter is adapted to transmit a portion of a program to the receiver during a subsequent transmit session, and the apparatus further comprises means for receiving a stop request, and means for terminating the transmit session in response to receipt of the stop request, wherein the means for generating bookmark data is adapted to generate subsequent bookmark data which is indicative of the progress of the subsequent transmit session.

Preferably the apparatus further comprises a controller for allocating the playout resource to the receiver during the first transmit session, and de-allocating the playout resource from the receiver after termination of the first transmit session.

Preferably the playout resource is an output channel of a playout computer.

Preferably the playout resource is de-allocated in response to expiry of the pause period.

Preferably the apparatus further comprises means for receiving a service request, and means for terminating the first transmit session in response to receipt of the service request, wherein the playout resource is adapted to transmit the data associated with the service request to the receiver.

Preferably the apparatus further comprises means for comparing the received service request with previously stored prioritisation rules to determine a priority level of the received service request, and means for terminating the first transmit session only if the priority level exceeds a predetermined threshold.

Preferably the apparatus further comprises a user input device for receiving and transmitting the service request.

The user input device may be any suitable device, such as a keyboard, mouse or microphone (in combination with suitable voice recognition software).

Preferably the apparatus further comprises means for generating bookmark review information in accordance with the stored bookmark data, and means for presenting the bookmark review information to a user.

Preferably the apparatus further comprises means for receiving a bookmark review information amendment request, and means for amending the bookmark review information data in accordance with the bookmark review information amendment request.

Preferably the apparatus further comprises a user input device for receiving and transmitting the bookmark review information amendment request.

The user input device may be any suitable device, such as a keyboard, mouse or microphone (in combination with suitable voice recognition software).

Preferably the apparatus further comprises means for receiving a bookmark amendment request, and means for amending the stored bookmark data in accordance with the bookmark amendment request.

Preferably the apparatus further comprises a user input device for receiving and transmitting the bookmark amendment request.

The user input device may be any suitable device, such as a keyboard, mouse or microphone (in combination with suitable voice recognition software).

Preferably the receiver is part of a local control unit having transmission functionality which enables the bookmark amendment request and/or bookmark review information amendment request and/or service request to be received from the local control unit.

Preferably the apparatus further comprises one or more additional playout resources for transmitting programs, to respective allocated receivers, and a controller for managing the allocation and de-allocation of the playout resources to the receivers.

### Menu of Bookmark Data

According to a further aspect of the invention, there is provided, a method of managing the distribution of data, comprising generating at least one piece of bookmark data to enable resumption of the distribution of a respective at least one piece of data which has been halted, and displaying a menu identifying such at least one piece of data.

### Allocation and De-Allocation at Will

In a further aspect, the invention provides a method of controlling the distribution of data between a server and a receiver, comprising providing a distribution means (such as a processor and associated memory); allocating the distribution means (such as a processor and associated memory) at will to distribute data between the server and the receiver; and de-allocating the distribution means at will.

### Dynamic Allocation of Distribution Means

The method may further comprise providing a further distribution means (such as a processor and associated memory); allocating the further distribution means at will to distribute data between the server and the receiver; and ensuring that at least one of the distribution means and the further distribution means is allocated to distribute data between the server and the receiver. The delivery of data to the receiver may be uninterrupted.

### Cease Allocation in Event of Halt

Preferably, the method may also comprise de-allocating the distribution means in the event of halting the distribution of data between the server and the receiver.

Typically, the halt may be a temporary halt or a permanent halt.

The method may further comprise generating bookmark data to enable resumption of the distribution of the data by a distribution means. The allocation or de-allocation may not be apparent, at the receiver, or to a user.

The method may also comprise halting the distribution of data in response to a user input.

The method may further comprise halting the distribution of data in response to a pause command, and de-allocating the distribution means upon expiry of a pause period following the pause command.

### Allocation of Playout Resources

In a further aspect of the invention there is provided apparatus for managing one or more playout resources, the apparatus comprising a controller for allocating the or each playout resource to a respective receiver during a transmit session, a bookmark generator for generating bookmark data, the bookmark data being indicative of the progress of the transmit sessions, and a memory for storing the bookmark data.

In a yet further aspect of the invention there is provided software for managing one or more playout resources, the software being configured to allocate the or each playout resource to a respective receiver during a transmit session, generate bookmark data, the bookmark data being indicative of the progress of the transmit session, and store the bookmark data.

In a further aspect of the invention there is provided a method of managing a connection resource, the method comprising: allocating the connection resource to a first receiver during a first connection session; generating firms bookmark data, the first bookmark data being indicative of the progress of the first connection session; storing the first bookmark data; de-allocating the connection resource from the first receiver after termination of the first connection session; allocating the connection resource to a second receiver during a second connection session; generating second bookmark data, the second bookmark data being indicative of the progress of the second connection session; and storing the second bookmark data.

Preferably the connection resource comprises an internet connection.

### Web Page Redirection Upon Start Up

According to another aspect of the invention, there is provided a method of managing a data distribution system, the method comprising receiving a request for data from a component of the system; determining a parameter, which does not represent a characteristic of the particular data requested; and, in dependence upon such parameter, either processing the request for data; or returning other data than the requested data to the component of the system.

Preferably, the parameter may be independent of the request for data.

More preferably, the parameter may represent a characteristic of earlier requests for data.

In one embodiment, the parameter may represent the number of earlier requests for data, which may be from a particular component and/or which may have been made during a particular time period and/or which may have been from a particular user.

Preferably, the method may comprise returning other data if the request for data is the first request for data, which may preferably be from a particular component and/or during a particular time period and/or from a particular user.

The request for data may be a request for data from a source outside the data distribution system. Furthermore, the processing of the request for data may comprise forwarding the request for data.

Preferably, the request for data may be a request for Internet data.

More preferably, the request for data may be a request for a home web page, in which case the further data may comprise a further web page.

Preferably, the device may comprise a receiver.

The device may comprise a portable computer, in which case, the method may preferably further comprise providing a connection for the portable computer to the distribution system.

The method may further comprise replacing the request for data with a request for other data.

Preferably, the data distribution system may include a local data distribution system.

More preferably, the local data distribution system may be located within, or may be associated with, a hotel.

A further aspect of the invention is now described, which provides at least one of the following features in combination one with another:—a mediating means, a system for distributing data, a server, a processor, a control means, a display means, a mediating means, an interface, a receiver, connection of laptop via LCU, and communication with user via television, no browser needed to communicate with guest, control of laptop by LCU, assignment of address, preferably IP address to laptop by LCU, simultaneous distribution of content via LCU to two devices, connection of laptop via LCU and simultaneous distribution of content to, for example, a television via an LCU, billing of laptop connection as function of time connected or as function of quantity of data transferred, control of content which can be viewed on laptop connected to Internet via LCU, connection to Virtual Private Networks, imitation of laptop by LCU, a head end server, a hub server.

The Laptop Connectivity service provided by the system allows hotel guests to use their personal laptop computer to access content and services delivered across the Internet. This enables guests to “surf” the Internet or to use the Internet as a communications path to the firewalls that control access to the guest's corporate network.

In a further aspect of the invention, there is provided a method of distributing a first set of data and a second set of data, comprising distributing portions of the first set of data interleaved with portions of the second set of data.

Thus a plurality of sets of data may be distributed simultaneously.

Such a method is particularly suitable for implementation using systems described herein, and in conjunction with methods described herein.

The first set of data may be a particular piece of content, for instance a film, and the second set of data may be another piece of content, for instance another film.

Alternatively, the first set of data and the second set of data may be data of different types, for instance any two of audio/visual data particularly digital television/video signals, text data, still images, moving images, Electronic Program Guides (EPGs), games, computer data particularly computer programmes or internet data and/or in different formats and/or subject to different encryption methods.

The portions of the first data set and the portions of the second data set may be interleaved temporally within a data stream. For instance, each portion of the first data set may be transmitted in a respective one of first set of packets, and each portion of the second data set may be transmitted in a respective one of a second set of packets, the packets being, for instance, IP packets. The packets containing the first portions of data, and the packets containing the second portions of data may be interleaved temporally within a data stream.

Upon receipt, for instance at a receiver, the portions of the first set of data may be processed to form the first set of data, and/or the portions of the second set of data may be processed to form the second set of data.

Alternatively, the portions of the first set of data and/or the portions of the second set of data may be retransmitted, for instance to an output device. For instance, if the first set of data contains audio/visual data representing a film, each packet containing a portion of the first set of data may be received at a receiver, for instance, a set top box, and then streamed to a display device, for instance a television, in real time, whilst simultaneously each packet containing a portion of the second set of data, for instance another film, a piece of music, or internet data, may be received at the receiver, and streamed to another output device, for instance a television, a speaker, or a computer in real time. Thus simultaneous real time streaming of multiple sets of audio/visual data distributed over a single channel may be achieved.

Preferably, the first and second sets of data are both distributed to the same device.

Preferably, the portions of the first set of data and the portions of the second set of data each contain an address identifying the device.

Preferably, the method further comprises labelling the portions of the first set of data; and labelling the portions of the second set of data.

Preferably, the method further comprises interrupting distribution of the first set of data during an interruption period; distributing portions of a third first set of data interleaved with portions of the second set of data during the interruption period; and resuming distribution of the first set of data at the end of the interruption period.

Preferably, distribution of the first set of data is resumed in response to user input.

Preferably, the method further comprises receiving the portions of the first set of data and retransmitting the portions of the first set of data to a first output device; and receiving the portions of the second set of data and retransmitting the portions of the second set of data to a second output device.

Preferably, the method further comprises receiving the portions of the first set of data and streaming the portions of the first set of data in real time to a first output device.

Preferably, the method further comprises receiving the portions of the second set of data and streaming the portions of the second set of data in real time to a second output device.

Preferably the method further comprises receiving and storing the first and second sets of data prior to distribution.

Typically the method further comprises dividing the stored data sets into respective portions. Thus, the size of the portions can be selected as desired.

Typically the method further comprises outputting the first set of data from a first output device; and simultaneously outputting the second set of data from a second output device. Thus, the data can be output simultaneously on a first device (such as a laptop), and a second device (such as a television).

Preferably, the method further comprises outputting portions of the first set of data from a first output device, and simultaneously outputting portions of the second set of data from a second output device, so as to give the impression to a user that the portions of the first set of data and the portions of the second set of data are received simultaneously.

Preferably, the method further comprises receiving and outputting a first portion of the first set of data on an output device, and subsequently receiving and outputting a second portion of the first set of data on the output device, such that there is a continuous output of the first set of data on the output device.

A further aspect of the invention provides a method of distributing data to a plurality of control units, the method comprising distributing a first set of data and a second set of data to a first one of the control units on a first channel by a method according to the previous aspect of the invention; and distributing a third set of data and a fourth set of data to a second one of the control units on a second channel by a method according to the previous aspect of the invention.

In a preferred embodiment the functions of the mediating means according to the first aspect of the invention, and the control units according to the further aspect of the invention, are each provided by a Local Control Unit (LCU).

A further aspect of the invention provides a method of distributing data comprising transmitting first and second sets of data from a central hub to a plurality of local servers; storing the first and second sets of data at each local server; and distributing the first and second sets of data from at least one of the local servers by distributing portions of the first set of data interleaved with portions of the second set of data.

In a further aspect of the invention, there is provided a method of distributing a first set of data and a second set of data, comprising distributing portions of the first set of data interleaved with portions of the second set of data.

Thus a plurality of sets of data may be distributed simultaneously.

Such a method is particularly suitable for implementation using systems described herein, and in conjunction with methods described herein.

The portions of the first set of data and the portions of the second set of data are preferably distributed across the same channel.

The first set of data may be a particular piece of content, for instance a film, and the second set of data may be another piece of content, for instance another film.

Alternatively, the first set of data and the second set of data may be data of different types, for instance any two of audio/visual data particularly digital television/video signals, text data, still images, moving images, IPGs, games, computer data particularly computer programmes or internet data and/or in different formats and/or subject to different encryption methods.

The portions of the first data set and the portions of the second data set may be interleaved temporally within a data stream. For instance, each portion of the first data set may be transmitted in a respective one of a first set of packets, and each portion of the second data set may be transmitted in a respective one of a second set of packets, the packets being, for instance, IP packets. The packets containing the first portions of data, and the packets containing the second portions of data may be interleaved temporally within a data stream.

Upon receipt, for instance at a receiver, the portions of the first set of data may be processed to form the first set of data, and/or the portions of the second set of data may be processed to form the second set of data.

Alternatively, the portions of the first set of data and/or the portions of the second set of data may be retransmitted, for instance to an output device. For instance, if the first set of data contains audio/visual data representing a film, each packet containing a portion of the first set of data may be received at a receiver, and then streamed to a display device, for instance a television, in real time, whilst simultaneously each packet containing a portion of the second set of data, for instance another film, a piece of music, or internet data, may be received at the receiver, and streamed to another output device, for instance a television, a speaker, or a computer in real time. Thus simultaneous real time streaming of multiple sets of audio/visual data distributed over a single channel may be achieved.

In a further aspect of the invention there is provided apparatus for distributing a first set of data and a second set of data, comprising means for distributing portions of the first set of data interleaved with portions of the second set of data.

Preferably the first and second sets of data are both adapted to be distributed to the same device.

Preferably the portions of the first set of data and the portions of the second set of data each contain an address identifying the device.

Preferably the apparatus further comprises means for receiving and storing the first and second sets of data prior to distribution.

Preferably the apparatus further comprises means for dividing the stored data sets into respective portions.

Preferably the apparatus further comprises means for labelling the portions of the first set of data; and labelling the portions of the second set of data.

Preferably the apparatus further comprises means for interrupting distribution of the first set of data during an interruption period; distributing portions of a third first set of data interleaved with portions of the second set of data during the interruption period; and resuming distribution of the first set of data at the end of the interruption period.

Preferably distribution of the first set of data is adapted to be resumed in response to user input.

Preferably the apparatus further comprises means for receiving the portions of the first set of data and retransmitting the portions of the first set of data to a first output device; and means for receiving the portions of the second set of data and retransmitting the portions of the second set of data to a second output device.

Preferably the apparatus further comprises means for receiving the portions of the first set of data and streaming the portions of the first set of data in real time to a first output device.

Preferably the apparatus further comprises means for receiving the portions of the second set of data and streaming the portions of the second set of data in real time to a second output device.

Preferably the apparatus further comprises means for outputting portions of the first set of data from a first output device, and simultaneously outputting portions of the second set of data from a second output device, so as to give the impression to a user that the portions of the first set of data and the portions of the second set of data are received simultaneously.

Preferably the apparatus further comprises means for receiving and outputting a first portion of the first set of data on an output device, and subsequently receiving and outputting a second portion of the first set of data on the output device, such that there is a continuous output of the first set of data on the output device.

In a further aspect of the invention there is provided apparatus for distributing data to a plurality of control units, the apparatus comprising means for distributing a first set of data and a second set of data to a first one of the control units by apparatus as aforesaid; and means for distributing a third set of data and a fourth set of data to a second one of the control units by apparatus as aforesaid.

In a further aspect of the invention there is provided apparatus for distributing data comprising means for transmitting first and second sets of data from a central hub to a plurality of local servers; means for storing the first and second sets of data at each local server; and means for distributing the first and second sets of data from at least one of the local servers by apparatus as aforesaid.

Preferably the first set of data is internet data.

In a further aspect of the invention there is provided a method as aforesaid, wherein the data distribution system and/or the local data distribution system is adapted to distribute data to a plurality of different locations.

In a further aspect of the invention there is provided a method as described herein in any aspect for distributing data to a plurality of different locations.

Preferably the different locations are different locations within a building or a vessel.

Preferably the different locations are different dwellings in a neighbourhood.

Preferably the different locations are different locations within a hospitality environment.

Preferably the different locations are different rooms, suites or areas in an educational facility, a caring facility, a medical facility, a detention facility, an entertainment facility, a recreational facility, a hospitality facility, an office facility, a transport facility or any other facility including establishments, buildings or vessels where one group of people attends to another group.

Preferably the different locations are different rooms, suites or areas in a school, university, care home, hospital, cinema, hotel, restaurant, (cruise) ship, or office; or different cells in a prison.

### Double Back Channel—Apparatus

According to another aspect of the invention; there is provided, a data distribution system comprising a remote server and a local distribution sub-system including a local server, the local distribution sub-system including a component (such as a processor and associated memory) for transmitting data to the local server; and the local server including means (such as a processor and associated memory) for transmitting the data from the local server to the remote server.

Preferably, the system further comprises means (such as a processor and associated memory) for storing the data at the local server prior to transmission to the remote server.

The remote server may include means (such, as a processor and associated memory) for storing the data.

The local server may include means (such as a processor and associated memory) for processing the data before transmission to the remote server.

The remote server may include means (such as a processor and associated memory) for transmitting further data to the local server, and for distributing the further data within the local distribution sub-system.

The system may further comprise a plurality of local distribution sub-systems each including a respective local server; means (such as a processor and associated memory) for transmitting respective data from a respective component of each local distribution sub-system to a respective local server, and means (such as a processor and associated memory) for transmitting the respective data from each such local server to the remote server

### Diagnostic Information—Apparatus

The remote server may include means (such as a processor and associated memory) for analysing performance of the system in dependence upon the data.

According to another aspect of the invention, there is provided a data distribution system comprising a remote server and a local distribution sub-system, the remote server comprising means (such as a processor and associated memory) for receiving data from a component of the local sub-system; and means (such as a processor and associated memory) for analysing the performance of the data distribution system in dependence upon this data.

### Recording Keystrokes—Apparatus

The system may further comprise a user input device for generating the data.

### User Profile—Apparatus

According to a further aspect of the invention, there is provided, an apparatus for generating a user profile, comprising a local distribution sub-system; a remote server, means (such as a processor and associated memory) for transmitting user input data from a component of the local distribution sub-system to the remote server; and means (such as a processor and associated memory) for generating the user profile in dependence upon this user input data.

In another aspect, the invention provides apparatus for managing distribution of data, comprising a local distribution sub-system including a local server; and means (such as a processor and associated memory) for transferring a user profile from a remote server to the local server.

According to a further aspect of the invention, there is provided apparatus for managing the distribution of data, comprising a local distribution system including a local server; a store (such as a memory store) for storing a plurality of user profiles at the local server; means (such as a processor and associated memory) for receiving a request; means (such as a processor and associated memory) for selecting a user profile in dependence upon the request; means (such as a processor and associated memory) for generating data in dependence upon the selected user profile; and means (such as a processor and associated memory) for transmitting the data to a component of the local distribution system.

### XML/Distributing Data—Apparatus

According to another aspect of the invention, there is provided an apparatus for distributing data, comprising a first device for receiving data and associated data; a parser for parsing the associated data; means (such as a processor and associated memory) for processing the data in dependence upon the parsing of the associated data; and means (such as a processor and associated memory) for transmitting the data from the first device to a second device.

Preferably, the apparatus further comprises a third device for generating the associated data.

In another aspect, the invention provides, a local data distribution system including apparatus as hereinbefore described.

According to another aspect of the invention, there is provided a local data distribution system comprising means (such as a processor and associated memory) for associating associated data with data at a component of a local distribution sub-system; means (such as a processor and associated memory) for transmitting the data and the associated data to a device; a parser for parsing the associated data; and means (such as a processor and associated memory) for processing the data in dependence upon the parsing of the associated data.

### XML

In a further aspect of the invention apparatus for downloading data sets, comprising means for transmitting data sets along with a common header file for those data sets to a device.

Preferably the apparatus further comprises a plurality of local control units for receiving the data sets.

Preferably the apparatus further comprises means for transmitting a request for data which comprises a description of characteristics of the data.

In a further aspect of the invention there is provided apparatus for manipulating data, the apparatus comprising: means for downloading a file; means for determining the content of the file; a plurality of content processors for file manipulation; and means for selecting one of the content processors in accordance with the content of the file.

### Software Upgrades—Apparatus

According to another aspect of the invention, there is provided, a data distribution system comprising a remote server and a local distribution sub-system including a local server, the system including means (such as a processor and associated memory) for transmitting software from the remote server to the local server, and installing the software in a device within the local sub-system.

In a further aspect of the invention there is provided apparatus for installing software, comprising means for transmitting software to a location from a remote location, and means for installing said software.

In another aspect of the invention there is provided apparatus for installing software at a hotel, comprising means for transmitting software to the hotel from a remote location and means for installing said software.

Preferably the apparatus further comprises a receiver for audio/visual data located in a hotel room, and means for installing the software in the receiver.

Preferably the apparatus further comprises a server for receiving and distributing audio/visual data in the hotel, and means for installing the software in the server.

In a further aspect of the invention there is provided a hotel data distribution system comprising a server for receiving and distributing audio/visual data in a hotel, and means for installing the software in the server.

In another aspect of the invention there is provided apparatus for installing software, comprising means for transmitting software to a first device, means for transmitting the software thence to a second device, and means for installing said software in said second device.

According to yet a further aspect, the invention provides, a data distribution system comprising a remote server and a local sub-system including a local server, comprising means (such as a processor and associated memory) for transmitting data ftom the remote server to the local server; a store (such as a memory store) for storing the data at the local server; and a menu generator (such as a processor and associated memory) for generating at the local server a menu of data available for distribution within the local sub-system.

### Menu of Bookmark Data—Apparatus

According to another aspect of the invention, there is provided, apparatus for managing the distribution of data, comprising a bookmark generator (such as a processor and associated memory) for generating at least one piece of bookmark data to enable resumption of the distribution of a respective at least one piece of data which has been halted, and a display for displaying a menu identifying such at least one piece of data.

### Allocation and De-Allocation at Will—Apparatus

According to another aspect of the invention, there is provided, apparatus for controlling the distribution of data between a server and a receiver, comprising a distribution means (such as a processor and associated memory); means (such as a processor and associated memory) for allocating the distribution means at will to distribute data between the server and the receiver; and means (such as a processor and associated memory) for de-allocating the distribution means at will.

### Dynamic Allocation of Distribution Means—Apparatus

Preferably, the apparatus may further comprise a further distribution means; means (such as a processor and associated memory) for allocating the further distribution means at will to distribute data between the server and the receiver; and means (such as a processor and associated memory) for ensuring that at least one of the distribution means and the further distribution means is allocated to distribute data between the server and the receiver.

### Web Page Redirection Upon Start Up—Apparatus

According to another aspect of the invention, there is provided a data distribution system comprising means (such as a processor and associated memory) for receiving a request for data from a component of the system; means (such as a processor and associated memory) for determining a parameter, which does not represent a characteristic of the particular data requested; and, in dependence upon such parameter, means (such as a processor and associated memory) for either processing the request for data; or returning other data than the requested data to the component of the system.

In a further aspect of the invention there is provided apparatus as described herein in any aspect adapted to distribute data to a plurality of different locations.

Preferably the different locations are different locations within a building or a vessel.

Preferably the different locations are different dwellings in a neighborhood.

Preferably the different locations are different locations within a hospitality environment.

Preferably the different locations are different rooms, suites or areas in an educational facility, a caring facility, a medical facility, a detention facility, an entertainment facility, a recreational facility, a hospitality facility, an office facility, a transport facility or any other facility including establishments, buildings or vessels where one group of people attends to another group.

Preferably the different locations are different rooms, suites or areas in a school, university, care home, hospital, cinema, hotel, restaurant, (cruise) ship, or office; or different cells in a prison.

The invention extends to a facility having different locations, a building, vessel, neighbourhood with dwellings, hospitality environment, educational facility, a caring facility, a medical facility, a detention facility, an entertainment facility, a recreational facility, a hospitality facility, an office facility, a transport facility or any other facility including establishments, buildings or vessels where one group of people attends to another group, school, university, care home, hospital, cinema, hotel, restaurant, (cruise) ship, or prison, incorporating apparatus as described herein.

A further aspect of the invention is now described, which provides in any appropriate combination, a method of managing a data distribution system as aforesaid, a method of analysing the performance of a data distribution system as aforesaid, a method of generating a user profile as aforesaid, a method of managing distribution of data as aforesaid, a method of managing diagnostic information as aforesaid, a method of downloading data sets as aforesaid, a method of requesting data as aforesaid, a method of manipulating data as aforesaid, a method of installing software as aforesaid, a method of installing software at a hotel as aforesaid, a method of transmitting a program to a receiver as aforesaid, a method of controlling the distribution of data as aforesaid, a method of managing a connection resource as aforesaid, a method of distributing a first set of data and a second set of data as aforesaid, a method of distributing data to a plurality of control units as aforesaid.

According to a further aspect of the invention, there is provided a computer program adapted to carry out any of the methods as aforesaid.

According to another aspect, there is provided a computer readable medium having stored thereon a computer program as described above.

In a yet further aspect of the invention, there is provided a signal, tangibly embodying a computer program product as aforesaid.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

In a further aspect of the invention, there is provided a system configured to distribute data by a method according as aforesaid, the system comprising a server for distributing the data, and one or more units for receiving and processing the data.

There is also provided a system configured to distribute data by a method as aforesaid, the system comprising a central hub; a plurality of local servers for storing and distributing the data; and one or more units for receiving and processing the data.

There is also provided a computer program adapted to carry out a method as aforesaid, and a computer readable medium having stored thereon such computer program.

The invention also extends to a processor, a memory, a system for distributing data, a control means, a local, server, a head end server, a local control unit, a receiver, a receiving means, a remote server, a hub server, a controller, a hard disc, a switch, an IGMP switch, a transmission means, a back channel, an interface, a cache memory, a generator, a generating means, a distribution means, a playout card, a playout computer, a gateway server, a communications manager, a decoder, a receiver/decoder, a firewall, a database, an upgrade manager, an archive manager, an event monitor, or a display, which embodies any aspect of the invention as herein described, including an apparatus, a system, a computer program, a computer readable medium, a signal, or a computer product.

Further preferred features of the invention will now be described, purely by way of example, with reference to the accompanying drawings, in which:—

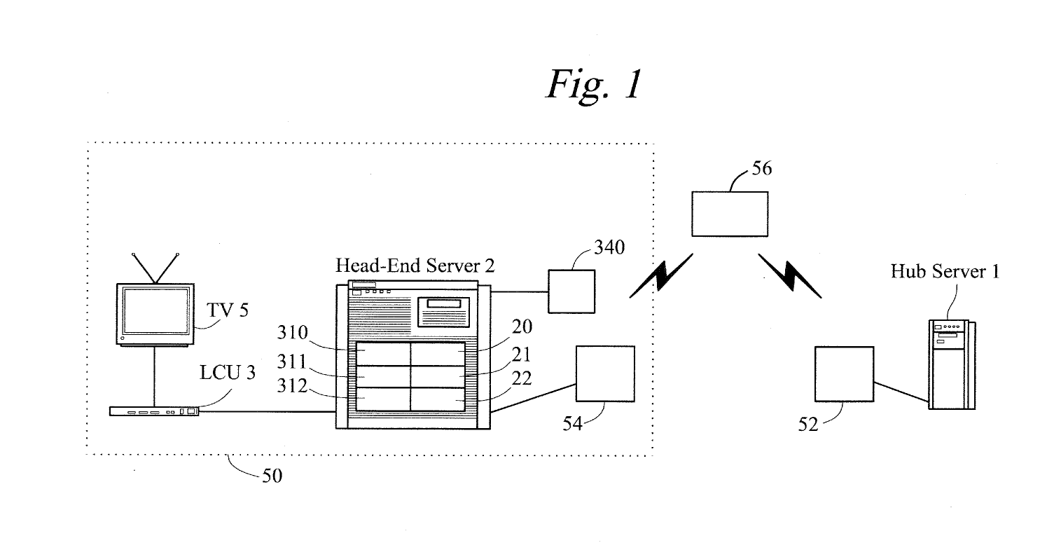

FIG. 1 is a schematic diagram of a media distribution/networking system;

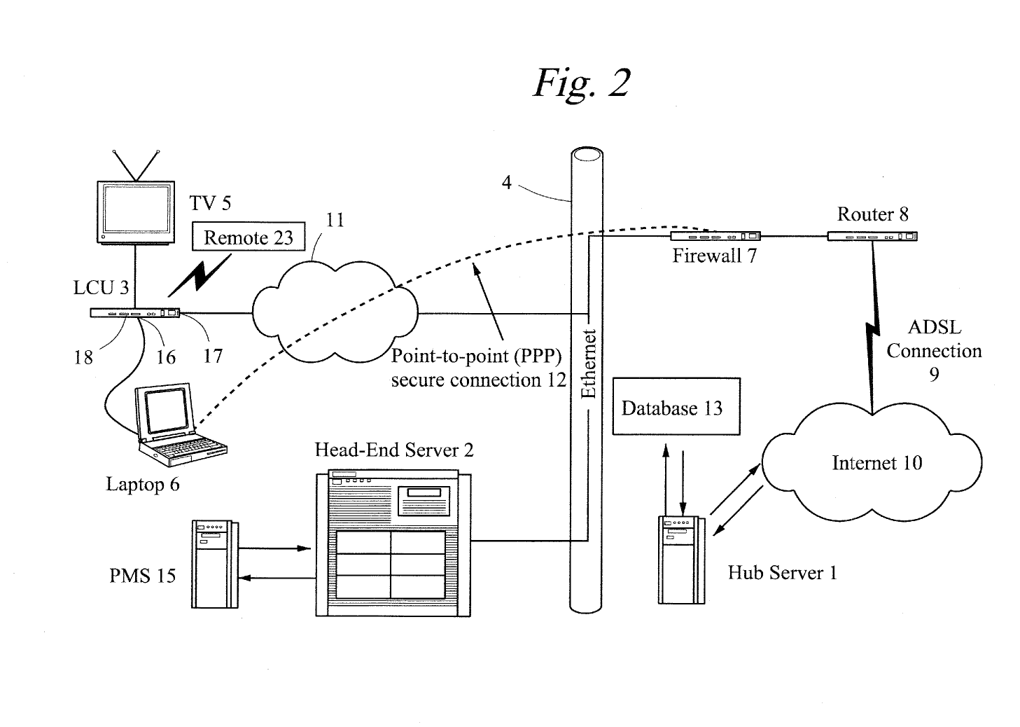

FIG. 2 is a more detailed schematic diagram of the media distribution/networking system of FIG. 1;

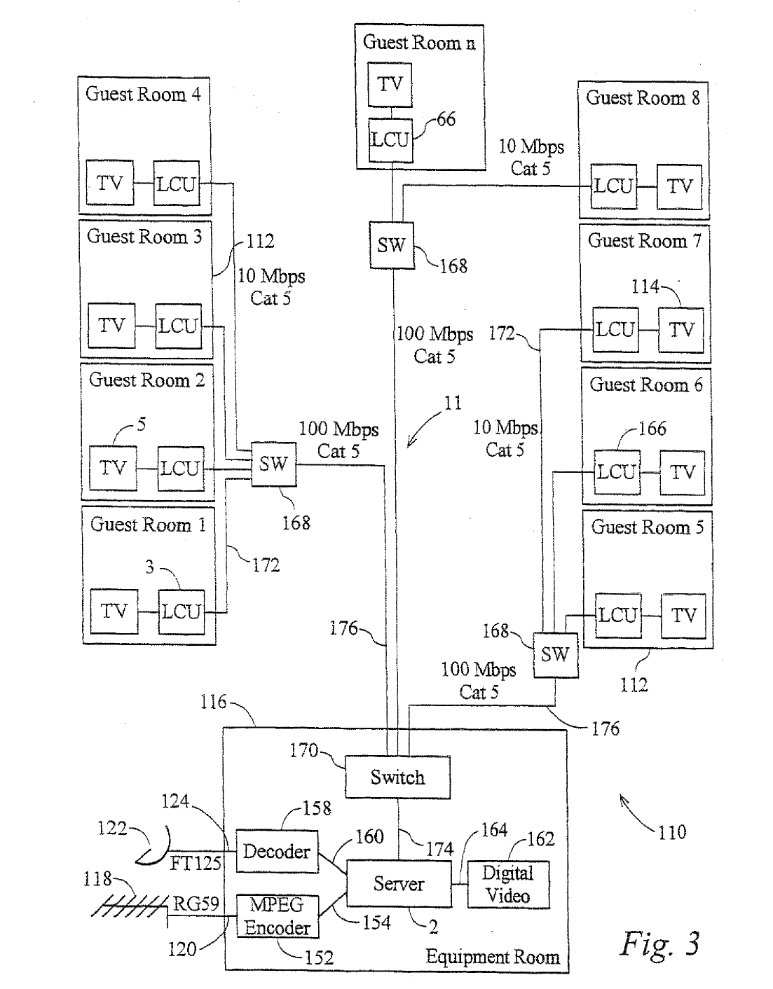

FIG. 3 is a more detailed schematic diagram of a variant of the media distribution/networking system of FIG. 1;

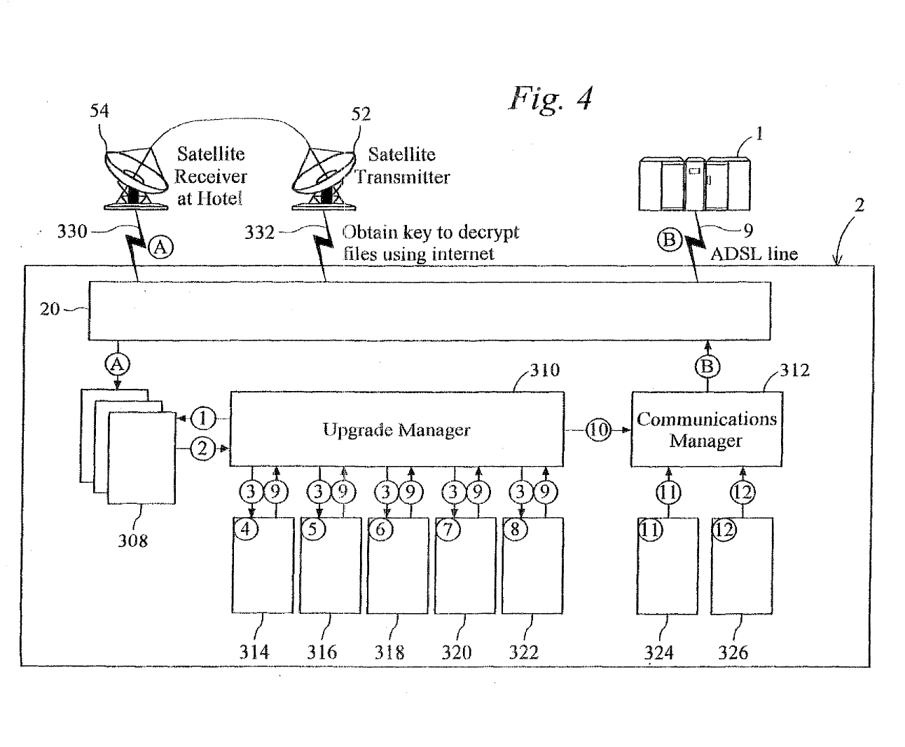

FIG. 4 is a further more detailed schematic diagram of a variant of the media distribution/networking system of FIG. 1;

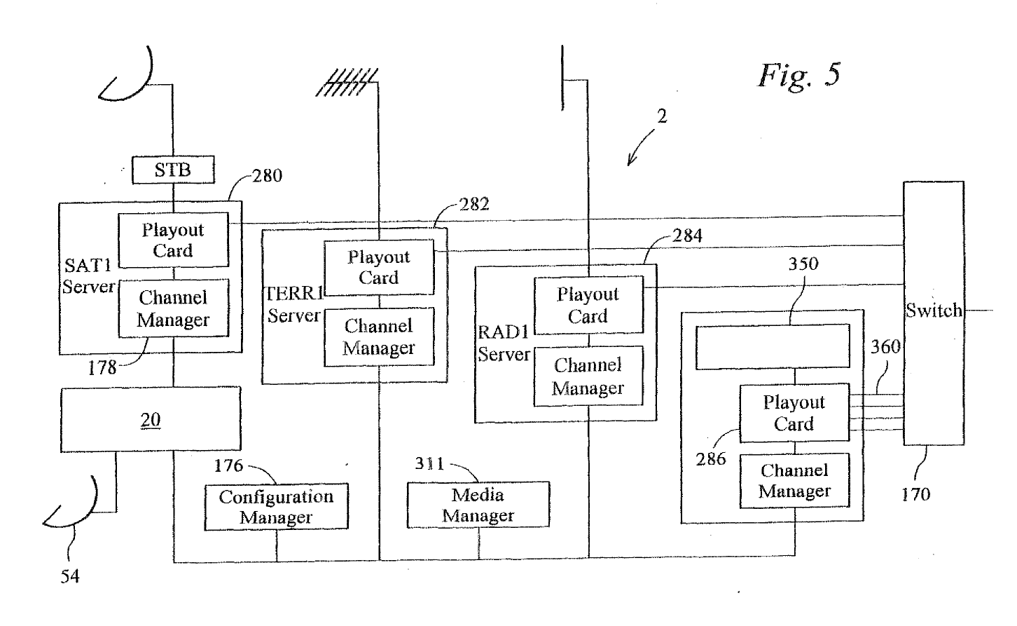

FIG. 5 is a block diagram of a server in the systems of FIGS. 1, 2, 3, and 4;

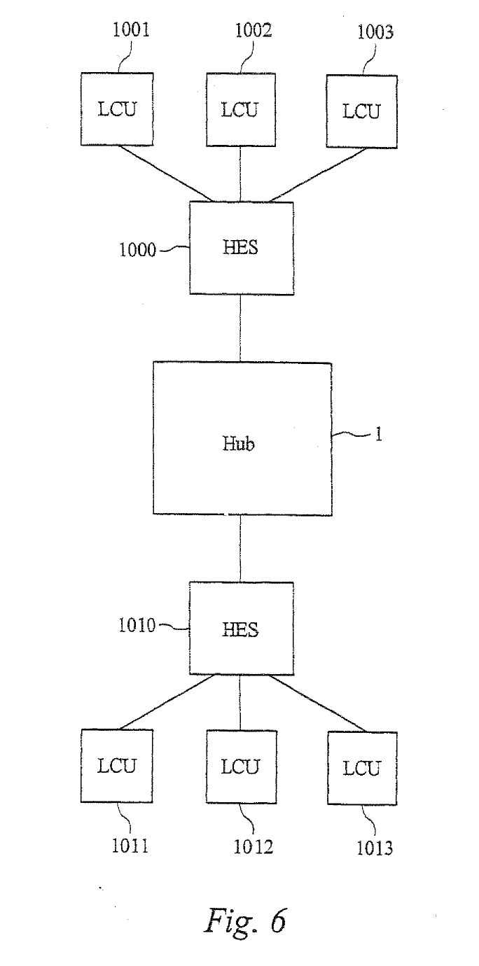

FIG. 6 is a schematic diagram showing connections between a Hub, a plurality of Head End Servers (HES's) and a plurality of Local Control Units (LCUs);

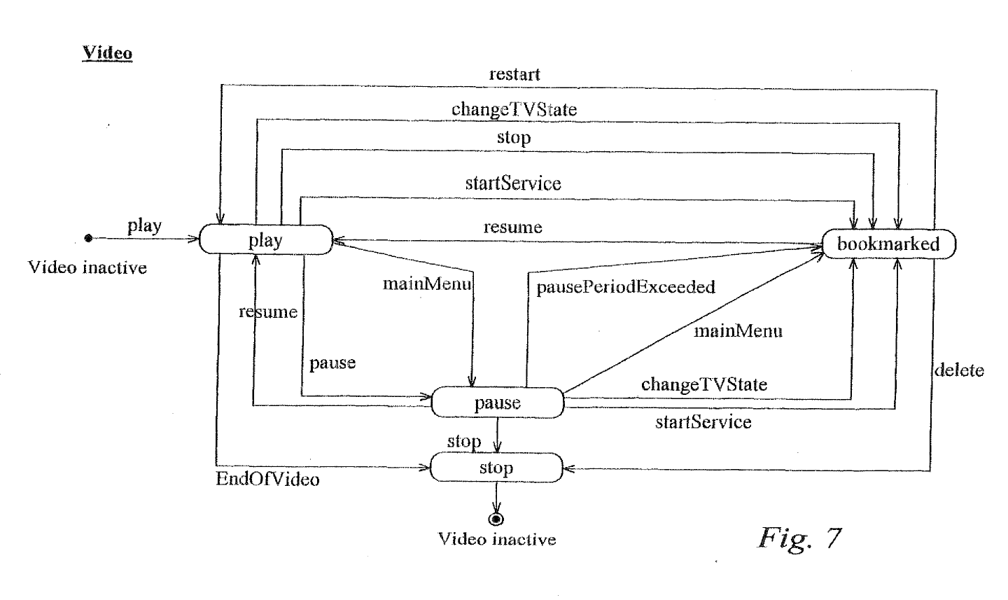

FIG. 7 is a state diagram showing video output session states and transitions between these states in the preferred embodiment;

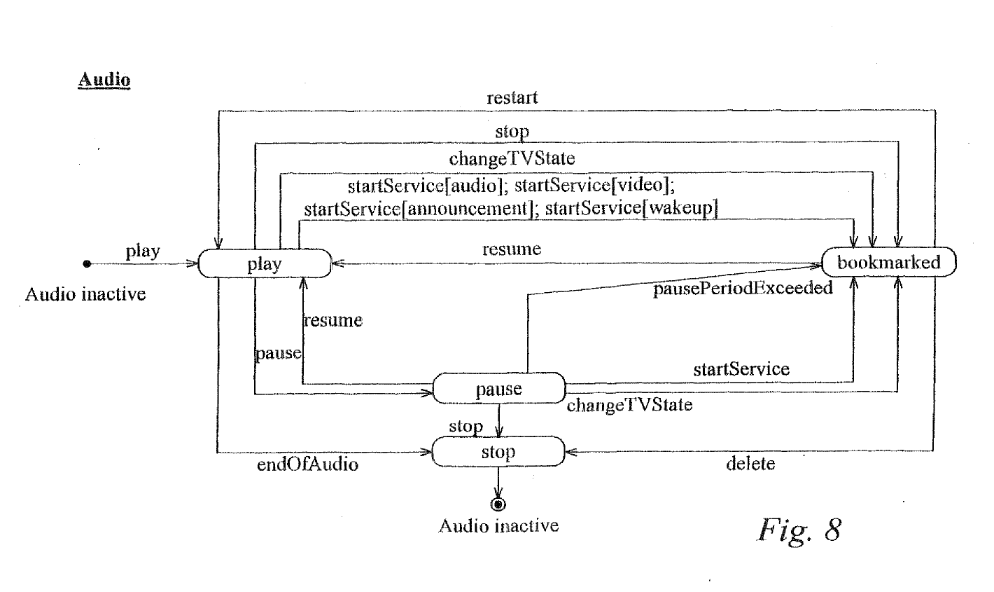

FIG. 8 is a state diagram showing audio output session states and transitions between these states in the preferred embodiment;

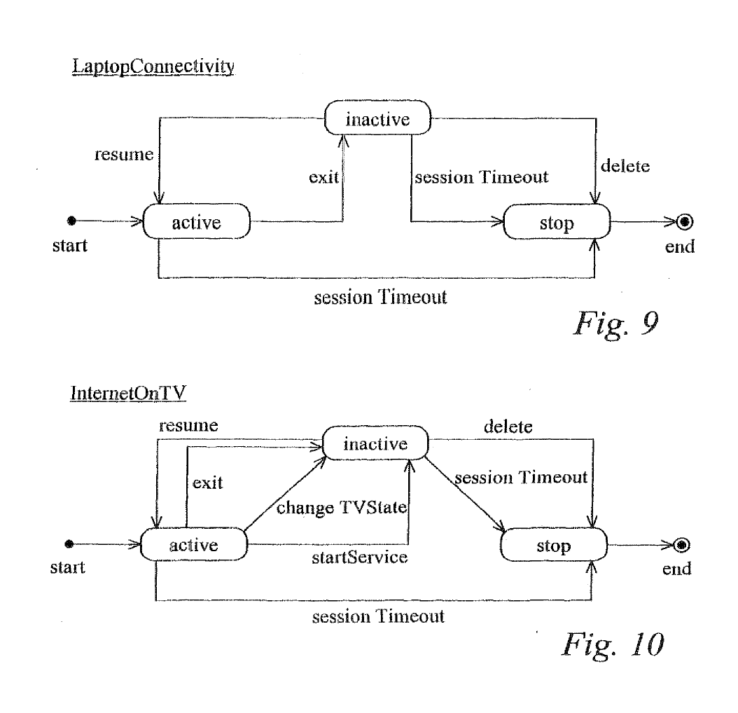

FIG. 9 is a state diagram showing laptop connectivity session states and transitions between these states in the preferred embodiment;

FIG. 10 is a state diagram showing internet on TV session states and transitions between these states in the preferred embodiment;

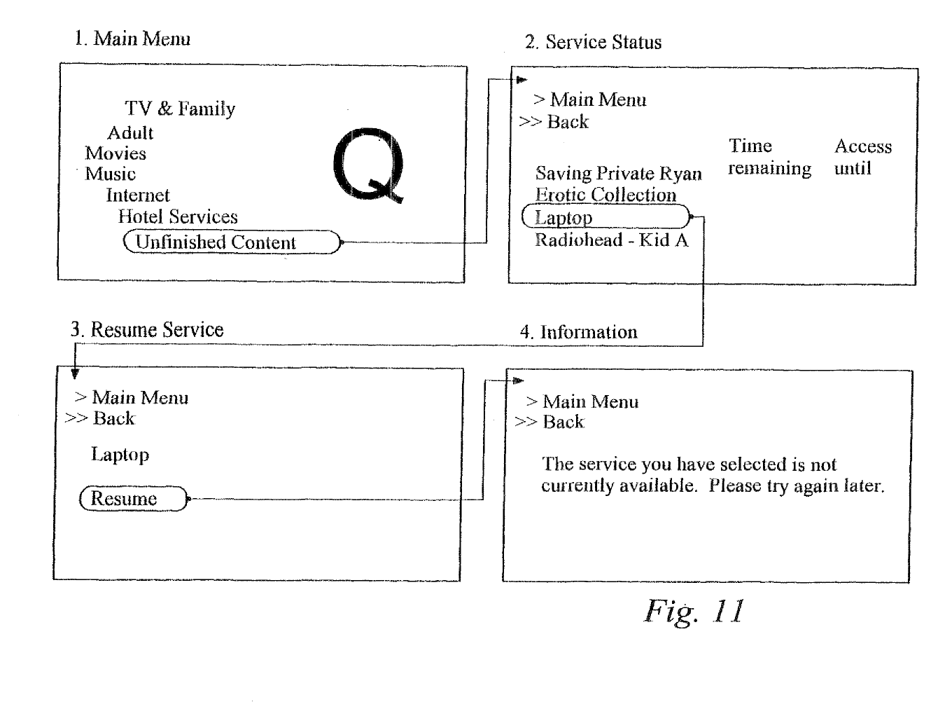

FIG. 11 is a diagram illustrating features of menu and other control screens relating to bookmarking;

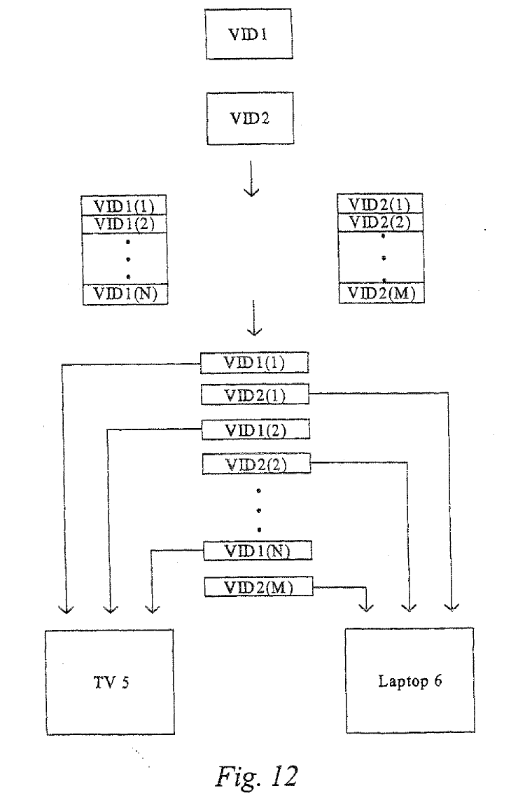

FIG. 12 is a schematic diagram showing the interleaving of two video files during transmission over a common channel; and

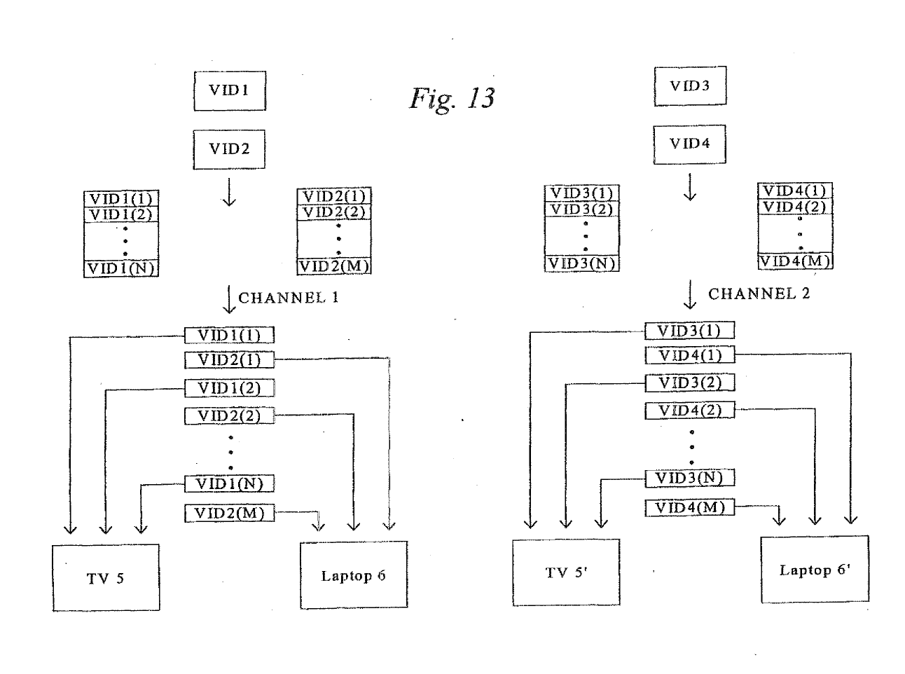

FIG. 13 is a schematic diagram showing the interleaving of four video files during transmission over two separate channels.

A high level overview of the system is now provided. This is followed by a more detailed description of communication within the system, including the processing and distribution of data received at a site, particularly as this relates to the installation of software, and the generation of diagnostic information. There then follows description of the tailoring of the system to particular users, and the bookmarking of content by a user. There is then some discussion of the interleaving of data, which is an important feature of the system and which increases its versatility in dealing with a range of different types of data. Finally there is some further description of general capabilities of the system and some description of alternative embodiments.

### 1. OVERVIEW OF SYSTEM

The media distribution networking system, or data distribution system, shown in FIG. 1 supports the reception of data streams from a central hub, including a server 1. The central hub server 1 provides data streams to one or more sites 50 remote from the hub server 1, and the data streams provided to the sites can be tailored to the requirements of the site. In particular, the central hub provides data streams to one or more hotels remote from the hub server 1, and the data streams provided to the hotels can be tailored to the requirements of the hotel.

Although only one site is shown in FIG. 1, it will be understood that in most cases the hub server 1 delivers data to more than one site.

A local distribution sub-system is located at each site. Components of such local distribution sub-system (a local server, referred to as a head end server 2, a Local Control Unit (LCUs) 3, and a TV 5) are illustrated in FIG. 1. Further components are illustrated in FIGS. 2 to 4 and discussed in more detail below.

In the preferred embodiment, the data streams are transmitted by a satellite transmitter 52 from the hub and received by a satellite receiver 54 at each site.

Upon receipt at a site, the data streams are processed and stored at a database 340 located within the Head End Server (HES) 2, which controls distribution of data streams to Local Control Units (LCUs) 3 at particular locations, for instance particular rooms, within the site.

In alternative embodiments, the database 340 can be separate from, but linked to, the head end server 2.

The system of FIG. 1 is illustrated in more detail in FIG. 2. The satellite transmitter 52, the satellite receiver 54, and the satellite 56 are not shown in FIG. 2. In the preferred embodiment a back channel is also provided from the HES at a site to the hub server 1 via an Ethernet network 4, firewall 7, router 8, Asymmetric Digital Subscriber Line (ADSL) 9 and the Internet 10. In alternative embodiments such internet link is used to distribute data streams from the hub to the sites in place of, or as back up to, the satellite link.

Although only a single LCU 3 is shown in FIG. 1 and FIG. 2, it will be appreciated that in general a large number of LCUs will be connected to each HES. For instance, in a hotel there would typically be a network of LCUs, with one LCU located in each guest room.

A variant of the preferred embodiment is shown in more detail in FIG. 3. The switched point-to-point digital distribution network 11 employs an infranet protocol (IP) and in particular the user datagram protocol (UDP/IP). In an equipment room 116, the downlead 120 from the terrestrial television aerial 118 feeds a receiver and MPEG encoder 152 which provides digital MPEG video streams 154 for the received terrestrial television programmes to a server 2 (although one server 2 has been shown in the drawing, several such servers may be employed). Also, the downlead 124 from the satellite dish 122 feeds a decoder/descrambler 158 which provides digital MPEG video streams 160 for the received satellite television programmes to the server 2. Furthermore, the video replay equipment 162 has a digital output and provides digital MPEG video streams 164 for the video programmes to the server 2. The server 2 selects which of the video streams is to be transmitted to which room 112, and places the selected video streams on the digital network 11 using UDP/IP, or TCP/IP, each addressed to the selected room 112. In each room 112, the television 114 is connected to the network 11 by a local control unit (LCU) 3 that receives the video stream addressed to that room 112, decodes it, and supplies the resulting analogue video and audio signals to the television 5. Each LCU 3 is also operable to send requests over the network 138 to the server 2, for example to change the television/video channel supplied to that LCU 3.

The network 11 is designed to support a bandwidth of up to 10 Mbps for communication between the server 2 and each LCU 3. The components required to deliver this bandwidth will vary because of the different topology of each hotel—for example, the layout of floors, risers, and the location of the equipment room 116 in which the server(s) 2 is/are situated. The required bandwidth of 10 Mbps per LCU 3 can be delivered using a switched network built on one or more high speed (100 Mbps) switches 168 each having up to twenty three ports, for instance eleven ports, that are in turn linked to the server(s) 2 (and to each other) via a Gigabit switch or high speed backbone network linking switches 170. Each LCU 3 is connected to the network via such a 100 Mbps switch 168 and a Category 5 (ANSI/EIA/TIA-568-1991) unshielded twisted pair (UTP) cabling system 172 operating at up to 10 Mbps. Each switch 168 is connected to the backbone 174 using such a Gigabit switch 70 and a Category 5 UTP cabling system 176 operating at up to 100 Mbps. The server(s) 2 is/are connected directly to the Gigabit switch 170.

This architecture can be simplified for smaller installations that do not have high bandwidth requirements, by using 10/100 Mops switches with fewer ports, and by using a lower speed cabling system for the backbone network.

Connections between the HES 2 and LCUs 3 may be established, in various embodiments, via cabling, in particular Category 3, Category 5, telephone, or coaxial cabling, microwave or other electromagnetic wave linkage, satellite transmission, bluetooth, and combinations of these media. In certain environments, for instance within trains, connection between the HES 2 and LCUs 3 may be established by means of radio links rather than, or in particular embodiments in conjunction with, cabling.

In the preferred embodiment data is transmitted between the HES and an LCU using User Datagram Protocol (UDP/IP). In alternative embodiments other communication protocols are used, particularly other point to point communication protocols.

Each LCU is connected to at least one device, usually at least a television 5 or other display device. The LCU is also adapted to receive user input from a remote control unit 23. A user may thus control operation of a device attached to the LCU, or may communicate with the HES, for instance in order to request particular data or content.

The HES compares the data request with control criterion, to determine for instance whether the requested data is available, and whether the user is allowed to access that data.

The LCU mediates communication between the HES and devices connected to the LCU.

In the preferred embodiment, the HES receives a variety of data, including audio/visual data either from the Hub or from some other source such as the internet or terrestrial television or radio broadcasts, and distributes this data to LCUs. The LCUs generally output such received data to an associated device, for instance a television.

An LCU processes some such received data before outputting the data to an associated device. For instance, in the preferred embodiment the data transmitted between the HES and an LCU is digital data and any digital audiovisual data transmitted between the HES and LCU would typically be converted to analogue audiovisual data before being output to a television associated with the LCU.

In the preferred embodiment, the HES also transmits control and information messages to LCUs. Such messages, for instance IPGs, may be generated by the HES.

### 1.1 LCU

In the preferred embodiment, with reference to FIG. 2, each LCU 3 has a main Ethernet port 17 and communicates with the HES 2 via a communication path 11 and Ethernet network 4. Each LCU 3 also has a guest Ethernet port 16 and serial port 18 which enable a guest to plug in their laptop 6. In FIG. 1, for illustrative purposes the laptop 6 is shown, connected to the guest Ethernet port 16. Each LCU 3 is connected to a respective television set 5. The laptop 6 communicates with the firewall 7 via a point-to-point (PPP) secure connection 12. For the avoidance of doubt, the point to point secure connection 12 shown in FIG. 1 does not represent a direct physical connection between the laptop and the firewall; rather this point to point secure connection is established via the LCU 3 and the communication path 11. A remote control unit 23 provides user input commands to the LCU 3.

Two network interfaces are provided within the LCU 3: one to communicate with the Head-End Server (HES) 2 and one for the guest to plug-in their laptop 6. The network connection between the LCU and the HES is via a 10Base-T Ethernet network 4 that runs at 10 Mbps using an RJ-45 connector, into which a Cat-5 twisted pair cable is connected. Two different methods are provided to allow a guest to access the Internet via the hotel's “high speed” Internet gateway; a serial port 18 and a 10Base-T Ethernet port 16.

The 10Base-T port 16 runs at 10 Mbps and the laptop is connected using a Cat-5 cable plugged into an RJ-45 port on the TelePort. The port is wired up as per a hub, so that cross over cables are not needed.

The serial port 18 is a 9-way female D-type connector, which supports a connection speed of 115.2 Kbps.

The laptop 6 connects to the system using a TCP/IP protocol (over either IEEE 802.3 Ethernet for the 10BaseT connection 16 or PPP for the serial port 18).

### 1.2 Head-End Server

Although the HES 2 is illustrated in FIG. 1 and FIG. 2 as a single server, it will be understood that the HES 2 is a logical server that may be installed as one or more physical servers depending, for instance, on the number of LCUs 3 to be serviced, which in turn may be dependent, for instance, upon on the number of rooms in a hotel.

Within the HES are various server applications, including an Access Manager 21, a Billing Manager 22, a Gateway server 20, an Upgrade Manager 310, a Media Manager 311, and a Communications Manager 312, and a Configuration Manager 176.

The Access Manager 21 controls all of the services offered by the system, including access control permissions to services for each guest. The Billing Manager 22 controls all aspects of billing for the services used by guests. The Gateway Server 20 controls and monitors each connection between a laptop attached to the LCU and the firewall that connects the hotel to the Internet via the ADSL connection. The Gateway Server also passes connection and usage based data to the Billing Manager for processing.

The Gateway Server ensures that packets are routed securely to their inbound or outbound destination, manages the sessions, including initiation and termination, and monitors traffic flows and collect statistics.

The HES 2 is coupled to a Property Management System 15.

The HES 2 will now be described in more detail, with reference to FIG. 5.

The HES 2 processes input streams in a variety of formats (analogue, digital, compressed, encrypted, etc.) and outputs digital streams in MPEG-2 format to the switch 170 that supports Internet Group Management Protocol (IGMP). A channel controller uses IGMP to allow LCUs 3 to subscribe to any of the shared stream-based media services. The UDP/IP transport protocol is used for transmitting MPEG-2 streams to the LCU 3.

The HES 2 comprises media capture, compression, and streaming functions and includes a media manager 311 that handles media-related events. The media manager 311 collects channel and schedule information from a configuration manager 176 and then passes messages to a specific channel manager 178. These messages detail actions that need to be taken; for example, loading an asset file, or streaming an asset on a particular card/channel. The configuration manager 176 holds a central repository of system-wide information. This data is used to control many aspects of a particular installation. A subset of the configuration manager database holds information specific to the HES 2. This identifies the various servers, the cards that are registered, the channels that have been assigned, the loaded media assets and the overall schedule.

The server may also include the following components: television and radio cards 280,282,284 that receive analogue RF and satellite signals and convert them to digital signals in MPEG-2 format; television and radio cards that receive digital signals in MPEG-2 format; playout cards 286 that multicast an MPEG-2 or MP3 file over the hotel network; and the software for the HES 2, e.g. the channel manager 178, streaming components, etc. The HES 2 may, for example, be presented as an 8 unit rack for mounting in a “19 inch” cabinet. Inside the cabinet there are a motherboard (e.g. Intel 700 MHz processor, 256 MB RAM, and 18 GB disk), a PCI bus with 24 slots for the media cards, a 100 Mbps network card, power supply and fan. The HES uses a DHCP client to request IP addresses for each card installed, and an SNMP client that will report any change in the status of the cards to an SNMP server in the channel controller. Each media card 280-284 installed in the HES 2 is connected to the IGMP switch 170 by a Category 5 fly lead to a port on the switch 170. If more than one HES 2 is provided, each HES 2 is connected to a hub, so they can communicate with other devices on the network The switch 170 is connected to the network via its up-link port. The switch supports IGMP and runs at 100 Mbps. The number of ports on the switch 170 and the number of switches will depend on each installation.

The HES comprise at least one hard disc 350 on which data available for distribution is stored. The database 340 is located at or across the or each hard disc 350 or, in alternative embodiments, the database is located on a separate storage medium, such as another hard disc, in which case the or each hard disc 350 contains a copy of at least some of the data stored in the database.

### 1.3 Firewall

In the preferred embodiment, a firewall 7 is provided. The ability to route all Laptop Connectivity sessions to the Internet through one IP address reduces costs and increases security.

### 1.4 Hub

The hub comprises a storage means in the form of a database 13 installed in a memory, and at least one processor included within a hub server 1.

Content and related information, including films, music, software and software upgrades, still images, IPGs or information relating to IPGs, games and applications is stored in a database 13 connected to the hub server 1. Distribution of content to sites is controlled by the hub server 1.

Information relating to content, usage of content and distribution is received, stored, and processed at the hub, and sent to sites as appropriate. In particular, the databases 13 connected to the hub server 1 store information relating to content and content files and EPGs, such as title, status, digitisation status, ordering information, preparation information, license information, running time, category, file size, filename, artist, genre, core album status, language, file id, file status, supplier, quality control status. Such information can be modified by the hub server 1.

Other information stored in the database 13 includes site or hotel details, including location, id, city, telephone number, system details, configuration files, pricing, and update details.

The hub server manages the distribution of data stored in the database to sites, for instance hotels. The data is sent, via a dedicated leased line, to a satellite communication provider, which is responsible for transmission of the data from the satellite transmitter 52, and reception of the data at the satellite receiver 54.

A processing means, in the form of a processor at the hub server is responsible for preparing data for distribution to sites. As discussed in more detail below, in particular in connection with the Upgrade Manager, particular sets of data are linked by XML header files which describe the content and correlation of the sets of data. The XML header files also provide instructions for how data is to be processed and/or stored upon receipt at a site.

Links between the hub server 1 and hotels or other sites enable information concerning content usage and other information to be transferred between the hub server 1 and the hotels or other sites. Such information includes content available at particular hotels or other sites, total and available storage capacity, information relating to available content, channel information, and usage information, either aggregate or individual, for instance on a per room, per stay, per guest, per hotel, or per time period basis. Such data is stored and processed by the hub server 1 and databases 13.

Indeed, as discussed in more detail below, any data relating to the system, or usage of the system, can be transmitted from components of the system to the head end server, stored at a database at the head end server and subsequently transmitted to the hub server. The hub server can thus monitor any aspect of the system.

A back channel is provided between any component of the system at any site and the hub server. The hub server is also able to distribute any piece of data, including software, to any component of the system at any site. However, as discussed in more detail below, the distribution of content is controlled locally in the preferred embodiment.

In one implementation of the preferred embodiment, the data streams are sent via a satellite link to the HES 2, and files are extracted from the data streams at the HES 2 if the files are directed to that hotel.

The list of hotels or other sites to which a data stream is directed is included in an XML file sent with data to the satellite communication provider. It is the responsibility of the satellite communication provider to construct the data streams from the data sent from the Hub.

The data streams include video and audio programmes, screen shots, electronic programme guides, executable files, requests for information, commands, applications and application updates.

In particular the data streams include data upgrades including software upgrades, and the upgrades are executed automatically at the server upon receipt of files from the data streams.

### 1.5 Laptop Connectivity

The laptop connectivity function enables a guest to connect a PC to the Internet by connecting into the guest Ethernet port of the LCU unit. Traffic is routed through the system network to an external firewall and the Internet beyond.

The guest achieves access to the Internet with a minimum of fuss. The following is assumed:
The guest laptop has a generally reliable 10BaseT-capable Ethernet interface
The guest laptop has a generally reliable TCP/IP network stack.
If the guest laptop has a static IP address defined, it also has a gateway and Domain Name service (DNS) server setting defined.

The LCU offers the following to the laptop:
A DHCP server issues an IP address, gateway and DNS server to a laptop which has a DHCP client
IP address faking to a laptop with static IP address. This allows the laptop traffic to pass through the network with a valid routable IP address.
DNS request redirection to the local DNS server for when the laptop has a fixed setting.
Acts as a gateway when the laptop expects a gateway to exist.

The HES passes IP addresses for the second interface of the LCU and for the laptop at the time it asks to activate the laptop interface.

Most of the initialisation is actually done when the head-end server calls a start Laptop Connection RJ45 function for the first time.

A function is invoked to attach a TCP/IP stack to the LCU's guest Ethernet port.

The IP address assigned to the laptop is added to the LCU's host table.

Finally a function is called to launch a DHCP server on the guest Ethernet port. This server is configured to provide only one address—that which is assigned to the laptop. It is also set up to provide the address of a DNS server (currently the same one offered to the LCU by the head-end server in its own DHCP service) and to set the default gateway of the laptop to be the LCU itself.

The HES will have provided an IP address for the LCU's guest Ethernet port, an IP address to assign to the laptop and a netmask which describes the two addresses as being on the same subnet while providing differentiation from the IP address of the main network pert.

This degree of setup is sufficient for supporting a laptop with a DHCP client. It broadcasts a request for a DHCP server to the Lars guest port—the LCU responds with the assigned IP address, DNS server setting and itself as the default gateway. Traffic from the laptop arrives at the LCU which then routes it out its own default gateway provided by the HES. Traffic arriving at the LCU for the laptop is routed through to the guest port using normal routing procedures.

### 1.6 Internet on TV

In the preferred embodiment, Internet on TV sessions are hosted by a Windows 2000 server Citrix Terminal Services.

A Citrix session manager installed on the Windows2000 Citrix Terminal Server monitors logged on Citrix sessions and notifies the Gateway Manager when a session closes. The Service can accept a request to logoff a named user session.

A custom Internet Explorer is used for Internet on TV. It communicates with the GatewayManager stream socket server using XML to request user & tariff details, notify application exit and subscription timeout. All required parameters are sent by the GatewayManager to the LCU in the request to start the Citrix client.

Genbrowse is installed on the Windows 2000 Citrix terminal server and is available to all users.

### 2. COMMUNICATION WITHIN THE SYSTEM

There is now provided a high level overview of the communications that take place between the hub server 1, hosted at headquarters, the HES 2 installed at each hotel, and LCUs. The overview clarifies the role of each server and the core services that support communications. FIG. 4 illustrates the architecture and core services referenced in the overview.

Aspects of the HES relating to the selection, storage and redistribution of content and of other data, particularly software are described in detail. These aspects of the HES include the Gateway Server 20, which provides a connection between the HES and the outside world, the Upgrade Manager which handles incoming data, and which is responsible for high level management of the upgrading, updating, or loading of content or other types of data, and the Communications Manager which handles outgoing data, and which is responsible for monitoring and communicating diagnostic data, and data relating to system usage or events.

Particular attention is paid to the types of data which are sent between the Hub, the HES, and LCUs and how this data is stored and processed, and to the distribution and installation of software, the generation and distribution of diagnostic information relating to various devices within the system, and the distribution, storage and analysis of information relating to user preferences and actions at the HES and at the Hub.

There then follows description relating more closely to the control of distribution of data to a user, and the interaction of a user with the system, particularly the bookmarking of content or other types of data, and the billing of a user.

Finally, features of the system relating to the distribution of different types of content or data to a user and the output of this content or data by various output devices are described.

### 2.1 Gateway Server

The Gateway Server 20 as illustrated in FIGS. 1, 4 and 5 provides a single point of access between the outside world and the system. The Gateway Server is fitted with a RAID-5 disk system so that large files can be stored securely so that disk failure will not necessitate retransmission of files. The Gateway Server comprises two core components.

The primary mechanism for loading data onto installations, for instance across Europe, is the satellite receiver 54 and down-link 330. The down-link is an always open connection running at 2 Mbps, and is a fully managed service.

Files transferred via the down-link are encrypted prior to transmission from satellite transmitter 52 and are tagged so that the receiving software can determine whether the files should be loaded or ignored. Receiving software decrypts the incoming stream and determines whether the file should be loaded onto the HES 2. The streams processed by the software are written to files and directories named in the stream header.

The Gateway Server 20 supports a communication mechanism between the HES 2 and the hub server 1, and manages the physical details of the connection to the Hub server so that a variety of different communication options can be supported without having to reconfigure the internal applications. The Gateway Server also handles the buffering of messages to be sent to the hub server 1 in the event of the connection failing.

Each hotel is provided with a 1 Mbps ADSL connection 9 installed and managed by a variety of national telecommunication providers. However, in variants of the preferred embodiment the Gateway Server supports leased line, ISDN or POTS modem connections,

### 2.2 Stream Management Services

While the Gateway Server 20 acts as a communications bridge between the HES and the Hub server, there are two core services that are responsible for routing, managing and processing the streams and files being transmitted between the HES and the Hub server. These services are referred to as the Upgrade Manager 310, which handles incoming data, and the Communications Manager 312, which handles outgoing data.

The characteristics of input streams and operation of the Upgrade Manager, and the characteristics of output streams and operation of the Communications Manager are now discussed.

### 2.3 Input Streams

The primary path for data that is to be loaded onto the system is through the satellite link 330. The satellite link has a managed, always open, downstream bandwidth of 2 Mbps. The HES software uses the Internet (via the ADSL line 9) to request a key to decrypt the incoming assets, and also to request that damaged packets are retransmitted.

The following data are transferred from the hub server 1 to the HES 2 via the satellite link 330:
Media Assets 314; video and audio files in MPEG-2 format, and IPGs.
Application Releases; the boot image file for the LCU, object and executable files for each HES application, executable files containing DDL and DML commands for upgrading the database at the TES.
Configuration Information 320; files holding configuration data for applications, and DML scripts for loading configuration information into the database
User Interface Assets 322; Java Server pages, image and graphics files, and Java archive files that define and control the “look and feel” of the user interface.

As discussed in more detail below, such data is usually transmitted with an XML header file which defines the content and correlation of component parts of the data, and this XML header file defines how the data is processed upon receipt at the head end server.

### 2.4 Operation of the Upgrade Manager

The Upgrade Manager 310 provides a framework within which the transactions described below can be processed. The XML schema are defined for each class of input and output file referenced below.

The Upgrade Manager 310 monitors files being downloaded by software into the work area 308. This monitoring is performed via link 201.

When a complete file is downloaded into the work area 308, the content of the file is determined from the file name. For example, a suffix of “.sw” may indicate a zip file containing a software release. The advantage of this approach is that a single file encapsulates all component parts of the release, which may include an XML file, or an XML or other header, defining the content of the release, application object and executable files, an install program, help and support documentation.

In the case of a file containing a software release, the XML file or header defines the relationship between the component parts of the release, and may also include an identifier identifying in which component of the system the software is to be installed, and when the software is to be installed. In variants of the preferred embodiment, the HES analyses the XML file or header and the content of the release and decides itself to which component of the system the software should be directed. Software releases can be directed to any part of the system, including the EMS itself and LCUs.

In an alternative implementation, an XML file is downloaded which informs the Upgrade Manager of the name and content of a subsequent download file to be downloaded. This is more elegant and flexible, but requires slightly greater complexity within the Upgrade Manager, as the content file may not necessarily be the next file downloaded and indeed may never be downloaded, so the Upgrade Manager has to check and report errors back to the HES and then tidy up any orphaned XML files.

Once the Upgrade Manager 310 has determined the content of the file(s) that have been downloaded, the Upgrade Manager spawns a child content management process 314-322 to manipulate the files. Decoupling the processing of the files from the Upgrade Manager leaves the Upgrade Manager process as a framework within which a diverse collection of content processors can be supported.

### 2.4.1 Media Assets

This class of download files comprises a suite of large files, with an XML header file that defines that content and correlation of the files within the collection. A typical video asset will be shipped as eight 500 Mb files containing the film, and an IPG which could potentially be a series of other MPEG, JPEG and text files. An audio file could be shipped as a single 5 Mb file with an EPG in the case of a single, whereas a CD would be shipped as a collection of 5 Mb files and an IPG.

With reference to FIG. 4, the content management process 314 copies the files as a collection from the work area 308 to the Media Manager, and runs the installation program to update the register of media assets held on the LCU.

### 2.4.2 LCU Boot Image

Much of the software at an LCU is not permanently installed, but rather is installed each time an LCU is booted up, whereupon a boot image file is loaded to the LCU. The boot image file contains the software and other data required by the LCU.

Updating of software at the LCU in the preferred embodiment therefore comprises transmitting a new boot image file from the Hub to an HES, and subsequently transmitting the boot image file to the LCU.

The LCU boot image is a single executable file which is shipped with an XML file that defines when the upgrade is to be applied. With reference to FIG. 4, the content management process 316 copies the boot image file to the specified directory on the HES and adds an entry onto the Scheduler with instructions on when the LCUs are to be rebooted.

In alternative embodiments, particular software at an LCU is installed without rebooting the LCU and without re-installing other software at the LCU. In these alternative embodiments, the software is transmitted from the HES, interleaved with content or other data as necessary so that operation of the LCU is not interrupted. The software is stored locally at the LCU until the most appropriate moment for the software to be installed, in order to provide minimal disruption to the service provided to a user.

### 2.4.3 HES Applications

In the preferred embodiment, all upgrades to HES applications are applied through formal installation programs. An upgrade is packaged as a single download file which is a zipped file containing all of the files required to perform the upgrade successfully. The installation program is responsible for loading new object code and executables, as well as applying changes to database schema and content through DDL and DML scripts. The installation program is able to manage the rollback of the installation in the event of a failure to install one or more components.

With reference to FIG. 4, the content management process 318 copies the upgrade file to the specified directory on the HES and adds an entry onto the Scheduler with instruct ions on when the upgrade is to be applied, along with the name of the program to be run to install the files.

### 2.4.4 Configuration Information

In the preferred embodiment, all changes to configuration information held within the system are applied through formal installation programs. An upgrade is packaged as a single download file which is a zipped file containing all of the files required to perform the upgrade successfully. The installation program is responsible for replacing existing configuration files and applying changes to database content through DML scripts. The installation program is able to manage the rollback of the installation in the event of a failure to install one or more components.

With reference to FIG. 4, the content management process 320 copies the upgrade file to the specified directory on the HES and add an entry onto the Scheduler with instructions on when the upgrade is to be applied, along with the name of the program to be run to install the files.

### 2.4.5 User Interface Assets

This class of download files is a collection of Java Server pages, image and graphics files, and Java archive files that define and control the “look and feel” of the user interface. An XML header file defines the content and correlation of the files within the collection. The upgrade is packaged as a single download file which is a zipped file containing all of the files required to perform the upgrade successfully.

With reference to FIG. 4, the content management process 322 copies the upgrade file to the specified directory on the HES and adds an entry onto the Scheduler with instructions on when the upgrade is to be applied, along with the name of the program to be run to install the files.

It is the responsibility of each content management process 314-322 to notify the Upgrade Manager 310 of its status during execution and report the completion status to the Upgrade Manager upon termination.

The Upgrade Manager 310 reports the status of the content management processes back to the hub server 1, via a Communications Manager 312. In the event of failure to install the files or assets, the decision on the remedial action to be taken is made at the hub server 1.

### 2.5 Output Streams

The Communications Manager, as discussed in more detail below, is responsible for the communication of data from the head end server to the hub server. The Communications Manager is linked to a database 340, in which data to be sent to the hub server is stored. In the preferred embodiment, the database 340 is also used to store data received from the hub server. Connections between other components of the head end server, for instance the upgrade manager 310, and in particular the content management processes 314 to 322, and the database 340, in the preferred embodiment, are not shown in FIG. 4.

The primary path for data to be transferred from the HES 2 to the hub server 1 is through a Virtual Private Network (VPN). The link between the VPN and each hotel is the 1 Mbps ADSL connection 9. The following data are transferred from the HES to the hub server through the VPN:
Confirmation of receipt of file(s) received through the satellite link 330
Notification of the Hub server of the status of the installation of the file(s)
Diagnostic information. The HES can transmit diagnostic information to the hub server instantly (e.g. Simple Network Management Protocol (SNMP) traps)
Event Log data
Usage data.

The data are typically stored at a database at the head end server, and are transmitted to the hub server as desired. Data is usually transmitted to the hub server periodically, for instance once per day, although as mentioned above some data is sent instantly.

In the preferred embodiment, priority data is associated with data which are to be transmitted to the hub server, and transmission to the hub server is dependent upon this priority data.

For instance, certain usage data, such as a record of all user keystrokes over a certain period of time as discussed below, has a low priority and is thus transmitted to the hub server once per day. Other data, such as diagnostic information reporting errors at components of the system has associated priority data which is variable and represents the importance of the data. For instance, a serious error which causes the system to crash would result in the transmission to the HES of diagnostic information which would have a very high priority. The HES transmits such data to the hub server instantly.

Other data, such as date, time, a user identifier, or a system component identifier, are optionally associated with data sent from the HES to the hub server.

In the preferred embodiment, the system can be configured to store at a database at the HES, and to transmit to the hub server, any data which can be produced by any component of the local distribution sub-system.

An XML file is generated by the HES which identifies the content and correlation of components of data sent from the HES to the hub.

The particular data which is stored at the HES, the rules which are applied to determine priority data, and the rules applied to control transmission of data to the hub server are determined by an application running at the HES. This application and the parameters it applies to determine these matters can be altered by a user at the site, or can be altered by the transmission of an upgrade or amendment to the application transmitted from the hub server.

### 2.6 Operation of the Communications Manager

The Communications Manager 312 provides a framework within which the transactions described below can be processed. The XML schema are defined for each class of input and output file referenced below.

### 2.6.1 Diagnostics

With reference to FIG. 4, the Communications Manager 312 within the HES is able to transmit diagnostic information from any component at the hotel to the hub server whenever required. This information is used to notify a Management Console (not shown) at the hub server of an issue that needs to be addressed expediently, so installations can be managed pro-actively.

The Management Console outputs data to a user at the hub, via a display screen, and the user can monitor performance of the system at a particular site or across a plurality of sites. The Management Console is also able to send messages automatically. For instance, if the Management Console receives data representing a serious error at a particular site, it may automatically send an e-mail message to a responsible person at that site, and raise an alarm at the site and at the hub.

In the preferred embodiment; the Management Console also instructs the sending the data to a particular site in response to the receipt of particular data from that site. In one example, the Management Console instructs the re-sending of the data in response to the receipt of data from a site indicating that, data transmitted to a site has not been received correctly. In a further example, the Management Console instructs the sending and installation of a piece of software to a site in response to the receipt of data from a site that a corresponding piece of software at the site is malfunctioning.

Each component that is enabled for sending out diagnostic information either formats the data using SNMP protocol or sends the data as XML files. The data is sent to an Event Monitor 324, which then forwards the files to the Communications Manager for subsequent transmission to the hub server 1.

As discussed above, priority data is associated with diagnostic information, and transmission of the diagnostic information to the hub server is dependent upon this priority data.

The diagnostic information can be related to any aspect of the system. For instance, particular diagnostic information relates to the success or otherwise of the downloading and installation of software releases or other data as discussed herein. Such downloading and installation is also be initiated in dependence upon diagnostic information. Particular diagnostic information is also generated in response to tests requested by the Hub, or by an HES.

Diagnostic information includes error messages generated by components of the system. For instance, if a Billing Manager (responsible for billing of guests at a hotel) within the HES is not able to communicate with the Property Management System (PMS) 15 shown in FIG. 2, the Billing Manager generates an error message which is sent to the Event Monitor which assigns it a high priority and forwards it to the Communications Manager, which sends data immediately to the Management Console at the hub server.

### 2.6.2 Event Logs and Usage Data

On a scheduled basis, an Archive Manager 326 gathers all usage data, audit trails and event logs and sends them to the hub server using the Communications Manager. All data passed to the hub server are formatted as XML documents.

### 2.7 Usage Data

There follows more detailed discussion of some of the usage data which is monitored, stored and processed at the HES and the Hub, and which was mentioned above in connection with the Communications Manager.

In the preferred embodiment, such usage data includes data relating to viewing of particular pieces of content, for instance films or programmes available on a video on demand basis, or of scheduled services or of publically available channels, or of distribution of particular music tracks, albums or packages, and further includes data relating to internet access. Such data is variously maintained on a per room, per user, or per time period basis.

It is particularly useful to maintain such data on a per user basis, and in the preferred embodiment, this and indeed a range of other user related data is maintained.

In particular, in the preferred embodiment, all instructions are recorded at the HES 2. These instructions include, in particular, all instructions communicated by a user in the user's room, for example, and most specifically, those to or via the LCU 3 and/or the television 5, as sent by the remote 23 and/or a keypad/keyboard (not shown). In specific implementations of this further embodiment these instructions include (or also include) instructions sent by the hub server 1 to the HES 2 and instructions sent by the HES 2 to the LCUs 3.

The record of instructions is correlated or associated with data stored at, or accessible by, the HES and, in particular embodiments, the central hub server 1. The system enables a record to be built up of a particular user's preferences and history of use. The record for a particular user is accessible by servers at different hotels and, upon the arrival of a user at a particular hotel where the system is installed, the set up of the system in the user's room can be tailored in dependence upon the user's record.

The records of instructions are correlated or associated with, in particular embodiments for instance, a particular user's identity, the company for which a particular user works, times and dates of use, the identity of particular hotels or installations, the characteristics of a particular room, pricing and payment information, with responsiveness to marketing or sales information, with internet usage, or with usage of hotel facilities.

The records of instructions are sent to the Hub server, where analysis of the record of instructions is carried out and the user's profile is created or updated. A user profile is downloaded by a particular HES upon arrival of a user at a particular site, and is retained by is that HES on a temporary basis. The user profiles are maintained on a permanent basis at the Hub server. In alternative embodiments, user profiles are maintained, and analysis is carried out on a distributed basis across the Hub server and all HES's across the system.

A variety of statistical analysis techniques, including averages, correlations, and time series analysis, are applied to records of instructions and to user profiles at the Hub. These techniques can be applied, for instance, on a per user, per site, per company, or per time period basis. Results of such statistical analysis can be generated on receipt of request from a particular HES. In alternative embodiments, such statistical analysis is performed by individual HES's themselves.

In the preferred embodiment, the user's identity is notified to the system upon check in, although in alternative embodiments the user's identity is notified to the system by entry of a PIN number by a user with a remote control unit in the user's room. The PIN is sent via the LCU to the HES.

The set up of the system in a user's room is tailored in dependence upon the user's record. Primarily, the menu screens displayed to the user, the content and other data which is most readily made available to the user, and the billing options presented to a user are tailored in dependence upon the user's record. However, where the user's record includes a record of actions or preferences with respect to environmental or other parameters, for instance room temperature or lighting level, such environmental or other parameters can be tailored in dependence upon the user's record.

A worked example of recording instructions is given below with reference to FIG. 6.

A user visits a hotel with HES 1000 and LCUs 1001-1003. The user inputs various instructions to the LCU in their room, for example LCU 1001. The instructions are recorded by HES 1000 and used to compile a profile for that particular user. After the user checks out, the HES 1000 transmits the profile to hub server 1.

At a later time, the user checks into a different hotel with HES 1010 and LCUs 1011-1013. The user inputs certain personal details which are transmitted to hub server 1. These details enable the hub server 1 to retrieve the profile associated with that particular user. The retrieved profile is downloaded to HES 1010 and used to tailor the system.

For instance, the particular data presented to a user, and menus of data, are varied in dependence upon the retrieved profile.

In the preferred embodiment, the user profile is stored at the HES throughout the user's stay, and is deleted when the user checks out, or when the user has not used the system for a pre-determined period of time. The user profile stored at the HES is also updated periodically, usually by downloading an updated version from the hub, if the user stays at a hotel for a long period of time.

User instructions can be recorded from a number of different LCUs during a user's stay, if a user identifier is obtained each time the user uses a different LCU.

In alternative embodiments, the user does not need to input personal details into the system himself, but rather the devils are taken from data given by the user upon checking in, or for instance from their credit card data or loyalty card data.

In an alternative example, which is a variant of that described above,

Whilst the above examples have been directed specifically to embodiments within hotels, the features recited in these examples are also found in embodiments in a range of other environments, for instance those environments discussed in more detail later below.

2.8 Use of XML and Examples of Communication within the System

XML is used throughout the preferred embodiment of the system as it provides a framework within which data types and relationships between those data types can be defined, providing a versatile and powerful framework for distributing and processing related pieces of data or data types. It also provides a highly portable format as any device which is XML enabled can parse an XML file or header. Other languages or protocols which provide similar features can be used in alternative embodiments.

XML enables the creation and formatting of a document, page, or file structure and the definition of rules for processing such document, page, or file. Tags can be created for different types of data within the document, page or file and relationships between the data types can be defined.

A particular XML file is parsed using an XML a processor and according to a particular XML Schema or Document Type Definition (DTD). In the preferred embodiment, the MAL processor is linked to various applications which process the data following parsing.

Data is sent between components of the system, for instance between LCUs and the HES, between components of the HES, and between the HES and the hub server in XML format, or with an XML header.

Files in XML format or XML headers are also generated by components of the system, for instance the Communications Manager 312, the Upgrade Manager 310, the Content Management Processes 314 to 322, the Gateway server 20, the Hub Server 1, the Management Console, the LCUs 3, the Event Monitor 324, and the Archive Manager 326.

An example of the distribution of data from the hub server to a component of the local distribution sub-system, and the distribution of data from the component of the local distribution sub-system to the hub, in the preferred embodiment, is now considered.

A data file is sent in XML format from the hub server 1 to the satellite communications provider, with an XML header file which defines to which sites the data file is to be distributed. The XML file is parsed by the satellite communications provider, the data file is included in a transport stream which is addressed in dependence upon the information in the XML header and the transport stream is transmitted from the satellite transmitter 52 to satellite receivers 54 at the sites.

Processing of the data file at a site to which the data stream is addressed is now considered. The data file is passed to the Upgrade Manager 310 by the Gateway server 20. The data file is parsed by the Upgrade Manager, and an XML tag identifies the file as containing media assets.

A content management process 314 is started and other XML tags identify the content, location and correlation of MPEG files containing film data and the content, location, and correlation of description of content files within the data file.

As discussed above, the content management process 314 copies the files to particular locations within the database 340.

A request for data is then sent from an LCU 3 to the HES 2. The LCU sends this request as an XML file which is parsed at the HES. The parsed request is then passed to the appropriate application within the HES. In response, a data file is generated containing data from the description of content data which was earlier stored in the database 340, and containing display information. An XML header file is generated which defines the content and correlation of the description of content data and display data. The data file and the XML header file are transmitted to the LCU which parses the XML header file, and passes the content of the data file to appropriate processes in the LCU. Data is then displayed on the TV 5.

A user selects further data in dependence upon the data that is displayed, and a request for data is sent from the LCU to the HES, as an XML file, which is then parsed at the HES. The parsed request is passed to the appropriate application within the HES, and in response MPEG data, which was stored earlier in the database 340, is streamed to the LCU. In the preferred embodiment an XML header is sent with the MPEG stream, which is parsed and which provides information concerning the MPEG stream.

Throughout the processes described in the example above, data representing each key press made by a user is also sent from the LCU to the EMS, and is stored in the database 340. Similar user input data is also sent from other LCUs within the local distribution sub-system and is also stored in the database 340. In this example, associated data is stored with the key press data, namely the time and date the key press was made, a component identifier which identifies from which LCU the key press data was sent, data representing the data displayed on the TV 5 when the key press was made, and data representing other processes being performed by the LCU at the time the key press was made.

Once per day, all such user input data, and non-urgent diagnostic or other data, is sent from the I-MS to the Hub via the connection 9. The data is sent as an KM file, with XML tags defining the content and correlation of the data within the file. Upon receipt at the hub server, the XML portion of the file is parsed and the data is passed to the appropriate applications and stored or processed as required.

The key stroke data is stored in a memory at the hub, and a processor is used to analyse the key stroke data and other similar data which was received and stored earlier from the site discussed in the present example, and from other sites. In the present example, the analysis has the aim of determining the efficiency of particular menu screens; by analysing how a user navigates through a menu, for instance determining how many times a particular menu screen is returned to, and for how long a user views a particular menu screen, it can be determined how easy to understand or how confusing a menu screen is.

Typically, the recording of key stroke data, as described in the example above, only takes place for a limited period of time, or at a limited number of sites, and particular studies and analysis of aspects of the performance of the system have a pre-determined duration.

Instructions are sent from the hub to BBS's to be user in such studies to define which data is to be stored and sent to the hub. Such instructions are in the form of data defining study parameters, which again is sent with an XML header or incorporated in an XML file. The XML is parsed and the data defining the parameters is sent to the appropriate application within the HES. Alternatively, the study parameters are set locally by an operator.

It can be seen from the above examples that, in the preferred embodiment, the hub is able to manage centrally aspects of the distribution system, although responsibility for the distribution and presentation of data and communication within a local distribution sub-system at a particular site is devolved to applications-running at the HES at that site.

As discussed, in the preferred embodiment, the parameters and applications directed to the distribution and presentation of data and communication at a particular local distribution sub-system are transmitted and installed from the hub and data is sent back to the hub, meaning that no local intervention by an operator is required to operate the system. However, an operator is able to intervene locally as required in order to manage or amend such parameters or applications.

By way of further example, the following XML Document Type Definitions (DTDs) define the format of the data being passed between the hub server and the HES in the preferred embodiment.
Content and correlation of files within a video “package”
Content and correlation of files within an audio “package”
LCU software release details
HES application software release details; content and installation details for files within the software release
Content and correlation of files within a release of the user interface assets 322
Content and structure of diagnostic information
Content and structure of event logs
Content and structure of usage data

Requests for data in XML, format can be requests based upon particular characteristics of the data. For instance, all data of a particular type, for instance referenced by a particular XML tag, may be requested, or some of that data limited by a further criteria; for instance all data of a particular type stored within a particular time period.

### 3. BOOKMARKING

The bookmarking functionality, which enables users to stop and start streamed services from a defined position, is now discussed.

An overview of the bookmarking process, the generation and storage of bookmark data, and the types of data stored as, or with, the bookmark data is provided. Then specific examples of bookmarking of video, audio, internet-on-TV, and laptop connectivity services are discussed, with state diagrams illustrating possible systems.

In prior art systems, if an MEG stream is stopped, reselecting it involves a new charge and the service is started again from the beginning.

In preferred embodiments of the present systems, it is possible to ensure that if a stream is stopped for any reason, the exit point is bookmarked, ensure that if an Internet session is stopped the system knows how much access time remains to the user, restart services at a later time from the exit point, display a menu of bookmarked items or services which are available to be resumed/restarted, and reallocate playout resources upon stopping, pausing, or switching playout of content.

Bookmarking allows streamed services to be stopped on user request and then to be restarted from the same position at a later point in time. As the stream is stopped the media resources are freed facilitating better utilisation and availability of the media server.

Various embodiments described herein are directed to the distribution of content. In most such embodiments, such distribution of content may be stopped or paused upon command of a user, usually by operation of a remote control unit. In the preferred embodiment, content is automatically bookmarked when the distribution of that content is stopped or paused or when playout of new content is requested, by storage in a database 340 at a HES of data identifying the content, and data identifying the last portion of content that was transmitted to the local control unit.

For instance, a user may pay for two different films using a video on demand aspect of the system. They may then switch between watching one or other of the films. Each time they switch from watching one film to another, the point in the film at which they switched is bookmarked, and upon switching back to that film, the film is output from the last bookmarked point (or an earlier bookmarked point if selected by the user).

In variants of the preferred embodiment, playout of content can be paused or stopped and bookmarked upon transmission, or request for transmission, of data from the HES to the LCU. Such data can be, for instance, a general announcement, a message, an alarm call, or a fire alarm. Furthermore, a decision as to whether or not to thus pause or stop playout of content and bookmark the content can be made in dependence upon the priority level of the data (for instance a fire alarm would always take priority) and upon user preference, and in accordance with prioritization rules.

Other bookmark data includes encryption information, in particular a key enabling decryption of the content at the bookmarked point, billing information, in particular information relating to payment made by a user for a particular piece of content, entitlement information relating to how much further content a user is entitled to receive, and timing information relating to the time particular content was bookmarked. In particular embodiments, bookmark information is deleted automatically if bookmarked content is not accessed again within a specified time period.

### 3.1 Service State Changes

The following analysis presents a detailed view of the actual actions perform when requests are encountered for various different types of services, namely video, audio, laptop connectivity, and internet-on-TV services.

### 3.1.1 Video

On-demand video streams are initiated through the system. At any point whilst a video stream is playing the user can request to pause or stop that service.

When a guest stops a Elm by selecting Stop on the remote control or on screen Stop icon bookmarks the stream such that the guest is able to resume the stopped film at a later time from the exit point.

Pausing the service causes the stream to be paused, resulting in a still image on the TV. After a configurable pause period, the stream is bookmarked resulting in the image being cleared on the TV. The media server resources are cleared.

If the user chooses to resume the service within the pause period then the stream is restarted.

If the user wishes to restart a bookmarked video stream, the system determines the last position, the availability of the appropriate media server resources and then initiates the service from that position.

The state diagram of FIG. 7 identifies the main states of the video stream and transitions that cause the sate changes.

The function StartService referred to in FIG. 7 includes or covers Internet-On-TV, Laptop connectivity, messages, announcements, video stream, audio stream, and wake-up call functions.

The function ChangeTVState referred to in FIG. 7 includes or covers the functions TV Off (the TV is switched off), TV Standby (the TV is switched to standby) and analogue TV.

The guest has the option of either resuming stopped content from the beginning or resuming the content from the exit point.

In preferred embodiments, the selector screen for launching a service that has been purchased but not completed presents options for Resume, Play from start, or Cancel.

The term StartService, as shown in FIG. 7, on the state table means that if a new service is selected while an existing service is still actively allocated to an LCU, the existing service will be automatically bookmarked and closed down.

In alternative embodiments, a Stop transition from the play state in the video state diagram, FIG. 7, may be changed to End of Video. Furthermore, a new Stop transition is possible from the play to bookmarked state, and a new Restart transition is possible from the bookmarked to the play state.

### 3.1.2 Audio

On-demand audio streams are initiated through the system. At any point whilst an audio stream is playing the user can request to pause or stop that service. Pausing the services causes the stream to be paused. After a configurable pause period, the stream is bookmarked. The media server resources are cleared.

If the user chooses to resume the service within the pause period then the stream is restarted. If the user wishes to restart a bookmarked audio steam, the system determines the last position, the availability of the appropriate media server resources and then initiates the service from that position.

The state diagram of FIG. 8 identifies the main states of the audio stream and transitions that cause the state changes.

The functions startService[announcement] and startService[wakeup], shown in FIG. 8, refer to all services which require a buzzer.

The bookmarking rules of the audio service are able to take account of the prioritization level of an announcement. If the announcement priority is associated with a buzzer, the audio stream is bookmarked and terminated.

In alternative embodiments, the Stop transition from the play state in the audio state diagram, FIG. 8, may be changed to End of Audio. A new Stop transition is also possible from the play to the bookmarked state, and a new Restart transition is possible from the bookmarked to the play state. The startService transition that defines a move from play to bookmarked, can be extended to include all services that require a limner sound.

### 3.1.3 Laptop Connectivity

Users can initiate a Laptop Connectivity session through the system. Sessions are valid for a system configured session period (normally twenty four hours). During this period the user can use, leave and resume their session. If the session exceeds the session period, the user must start a new session.

The state diagram of FIG. 9 identifies the main states for a Laptop session and the transitions that cause the state changes.

### 3.1.4 Internet-on-TV

Users can initiate an Internet-On-TV session through the system. Sessions are valid for a system configured session period (normally twenty four hours). During this period the user can use, leave and resume their session. If the session exceed the session period, the user must start a new session.

The state diagram of FIG. 10 identifies the main states of an Internet-On-TV session and the transitions that cause the state changes.

Other internet session packages, for either Internet on TV or Laptop Connectivity sessions, are available to a user in the preferred embodiment. For instance, a user may be billed based upon the type or quantity of data sent to the user, or based upon connection time. A package purchased by a guest may provide unlimited Internet access within a fixed period of time, or a fixed number of login, or may provide for charging in proportion to connection time or type or quantity of data transferred, or may provide a unlimited access up to a certain limit, with additional charges for going beyond this limit.

Internet sessions may be bookmarked, taking account of the particular Internet session package applicable to a particular user.

It should be noted that, in alternative embodiments, Delete may not be available as a specific option on the Resume Service page.

Furthermore, in particular embodiments, the remote control's special function keys bypass the browser and can therefore lead to an inconsistent state in the browser and the LCU; e.g. if stop is pressed on the remote control, the browser will still assume that a stream is playing whereas the LCU will have requested the stream to stop. Such Special keys may be ignored at the Head-end to avoid this type of inconsistency.

### 3.2 User Experience

The capabilities of the system available to a user in the preferred embodiment are now described. There then follows a more detailed description of menu and control screens which are presented to a user, followed by some discussion of how these menu and control screens are generated by the system.

The following analysis also identifies how the user experience relates to the state diagrams described above.

As described above, a paying service that is stopped before completion is “bookmarked”. This defines the point at which the service will be restarted or for Internet sessions the remaining period of time that can be spent online.

The main menu is updated to present an extra “unfinished content” option.

Once a paying service has been stopped before completion, a menu option “Unfinished content” (or some similar title of maximum 19 characters length) appears on the main menu, as presented to a user. This option is only displayed if there are bookmarked services or uncompleted timed services. Selecting this option leads onto the new pages that allow access to bookmarked streamed content and other stopped services.

If this menu option is selected, the user is taken to a “status screen” showing which specific titles or services e.g. laptop Internet session are uncompleted. These unfinished services are displayed in chronological order with the most recently viewed title uppermost. The screen also shows how much time remains on a service or the time at which access rights lapse. This access time will be defined by time (24 hour clock) and date.

The service status page displays all the bookmarked streamed services and other time based services that the user has started (purchased) and stopped before completion (this could also include an audio stream that is currently playing). The services are displayed with information detailing the time remain (displayed in hours and minutes) and the time at which the service access will cease (displayed as a date and time). The user can navigate through the list of unfinished content and then choose to restart or remove a particular item by selecting a service.

The user is able either to resume a service or delete reference to it on the status screen. This applies specifically to adult material to allow the user to avoid potential embarrassment. Selecting one of these titles or services and pressing OK leads to a screen featuring the selected title/service and offering a choice of resuming the service or deleting the “bookmark”, whereas selecting “Delete” returns the user to the status screen.

Selecting “Resume” resumes the services as follows:—

Audio and video services are resumed from their bookmarked position, which is usually the point at which they were stopped.

Internet-On-TV and Laptop Connectivity services have their sessions resumed. An Internet session (where the guest had bought time online) is restarted at the home page allowing the guest to surf for remainder of the time originally purchased.

Except for adult material, PIN or room number entry is not required. Adult services require PIN entry prior to service resumption.

If the guest uses the navigational screens to reselect a service that has not been completed, the service is resumed without further PIN or room number input in the same way as if the service had been selected as described above.

If the service cannot be resumed because, for example, no video stream is available at that time, the guest is shown an advisory screen stating that the user should try again later.

The selected service is displayed with options to resume the service. Selecting Resume causes the service to be restarted:

If the requested service cannot be resumed then appropriate advisory text is displayed. This occurs when an audio or video service cannot be resumed, (e.g. when resources are not available on an appropriate media server), or when an Internet-On-TV, or Laptop Connectivity session cannot be started (e.g. if the service is over subscribed).

This exception information is recorded in the audit trail.

### 3.3 Menu/Control Screens

Features of menu and other control screens relating to bookmarking are now described in more detail, with reference to FIG. 11.

### 3.3.1 Main Menu

The Main Menu screen has space for seven main menu options: “TV and Family”; “Adult”; “Music”; “Internet”; “Hotel Services”; and “Unfinished Content”.

Once a chargeable service has been paid for but not completed, the “Unfinished Content” option appears at the bottom of the visible menu hierarchy. Selecting this option links to a “status screen” which shows which specific titles or services are uncompleted.

A default menu option is highlighted—for instance by displaying a box around the option. The default menu option is described below as a focus. For the Main Menu the focus is set on “TV and family”: the most popular Main Menu option.

### 3.1.2 Status Screen

The status screen is accessed via the “Unfinished content” option on the Main Menu screen.

The screen lists items of unfinished content, such as movies, music, or internet connection sessions. There is no TV & Movies graphic as unfinished content is combined across all genres.

The screen displays the time remaining for services such as Internet on TV which may be purchased by the hour. The screen also displays “Access until” which shows the time beyond which the service is no longer available. It is necessary to impose a cut off for movies etc if the Hub is attempting to remove old content as part of a schedule. “Access until” is given as a 24 hour clock reference+date defined as a numeral+name of month or abbreviation.

Selecting a title and pressing OK calls the next screen.

The user can return to the Main Menu either by pressing a “Menu” button on the remote control or by selecting a Main Menu option at the top of the screen.

The unfinished services are sorted by order of purchase, most recent purchase uppermost. The focus is set on “more options” if there are any, otherwise on the first unfinished title/service.

### 3.3.3 Delete/Resume Screen

The selected title or service is confirmed on the Delete/Resume screen.

Selecting Cancel and pressing OK on the remote control returns the user to the previous screen, whereas selecting Resume and pressing OK on the remote control restarts an audio or video service from the point at which it was stopped. It is not necessary to input the PIN or room number again.

Resuming an Internet session resumes the service from the Internet home page for a period equal to the remaining session time.

A guest has the facility to delete reference to a title that the guest may not want displayed for reasons of sensitivity.

The stream fires up immediately from the point at which the guest last exited it. The soundtrack is as originally selected.

It is possible that when the guest wishes to resume a service, no video stream is available. An advisory text to this effect is displayed.

3.3.4 Access of unfinished content from Main Menu screen

The guest may not notice the unfinished content option in the Main Menu screen, or appreciate its significance. In this case, the user may attempt to reselect a previously purchased film by the familiar route of navigating back through the menu screens. Even if the guest did not appreciate the significance of the Unfinished content option on the Main Menu screen, it is displayed on all menu screens up to the selector screen.

The guest arrives at a selector screen at which he attempts to restart/resume a film which has previously been purchased. The selector screen includes a synopsis of the film and three menu options. The system recognises that the film has already been purchased and the selector screen presents the guest with the options to resume the movie from the exit point, or to restart the movie from the beginning, or to choose again.

Resuming the movie is free, but restarting from the beginning is chargeable. The guest does not need to input the PIN or room number. If the guest wishes to restart the film from the beginning, then the next screen prompts the user to select or reselect a language choice. If the guest does not want to pay again for a previously purchased movie, he has the option of selecting cancel to return to the previous screen. The movie is fired up with on demand buttons being displayed for a configurable period then fading from the screen.

### 3.4 Design Detail

The following section details items which support the functionality described above. In particular, consideration is given to the changes that may need to be made to upgrade a system to support the bookmarking functionality.

In the preferred embodiment, the various menu screens available to a user are in the form of Java Server Pages. Such Java Server Pages include a Bookmark service status page, a service resume/restart page, audioplay.jsp and videoplay.jsp pages which support bookmarking, a purchase.jsp page which requests a PIN on resumption of an adult streamed service, and servicevod.jsp and serviceaod.jsp pages which allow resume or restart.

Appropriate text and translations are included in the property files.

In order to support the bookmarking functionality, various changes are necessary to Java classes or applications within the system. For instance, the service classes support methods that act on bookmarked and timed services. It may also be necessary to enhance the Gateway Server 20, and to arrange for the HES-LCU API to provide additional information messages.

The database at the HES must be updated to include a new category, a new service and an appropriate configuration to invoke the bookmark status page. Appropriate text and translations must be included in the database.

The Billing Manager may need to be enhanced if a system is upgraded to support Bookmarking.

3.5 User actions

As discussed above, the bookmarking on stop function is able to stop an audio or video stream and record the point of exit, to stop an Internet session and record the access time remaining (time purchased minus time elapsed), to permit a guest to resume an audio or video service from the point of exit subject to prevailing access rights, to permit a guest to resume an Internet session from the Internet home page for a period equal to the access time remaining. In general, the guest resumes the uncompleted service without being billed again and without having to re-enter a room number or PIN.

A table of some possible user actions and their associated impact on video-on-demand (VoD), audio-on-demand (AoD), Internet on TV, and Laptop Internet services is now provided.

| | Impact | | | |
|---|---|---|---|---|
| Action | VoD | AoD | Internet on TV | Laptop Internet |
| 1. User selects “stop” using remote control FLOF | Stream stopped | Stream stopped | Session stopped | Session continues |
| buttons or the on-screen “stop” functionality. | | | | |
| 2. User stops by logging out of the Internet session | N/a | N/a | Session stopped | Session stopped |
| 3. TV switched to standby | Stream stopped | Stream stopped | Session stopped | Session stopped |
| 4. TV powered off | Stream stopped | Stream stopped | Session stopped | Session stopped |
| 5. Second MPEG2 stream selected while an existing | Original stream | Original stream | N/a | Session continues |
| MPEG2 stream is already running. In this case, the | stopped | stopped | | |
| user will not first have to navigate back to the | | | | |
| original stream then close it before reselecting the | | | | |
| desired new service. | | | | |
| (This functionality assumes that the guest is | | | | |
| restricted to one MPEG2 stream at a time, which is | | | | |
| not the case in certain embodiments.) | | | | |
| 6. Internet on TV session launched | Stream stopped | Stream continues | N/a. See 8 | Session continues |
| 7. Laptop Internet session launched | Auto pause from | Stream continues | For laptop session to be | N/a |
| | menu selection | | launched, system would | |
| | converted to stop | | have to move from JVM | |
| | | | mode to ANT browser | |
| | | | mode. | |
| 8. Pressing “menu” on the remote control or the on | Stream auto | Stream continues | Citrix browser forced to | Session continues |
| screen main menu option (AoD and VoD) | paused. | | webpage with advisory | |
| | | | text. Choice of | |
| | | | terminating session or | |
| | | | cancelling selection. | |
| 9. Pressing “TV” on the remote control | Stream stopped. | Stream stopped. | Session stopped | Session continues |
| 10. Selecting the free to air TV option on the main | Pause (#8 above) | Stream stopped. | See 8 | Session continues |
| menu. | converted to Stop. | | | |
| 11. Expiry of the maximum configured period | Pause converted | Pause converted | N/a | N/a |
| allowed for a “pause” command | to stop | to stop | | |
| 12. Selection of the on-screen or remote control | Stream paused | Stream paused | N/a | Session continues |
| “Pause” button. | | | | |
| 13. Receipt of an announcement or message | Stream auto | Stream continues | See 8 above | Session continues |
| | paused | | | |
| 14. Any other remote control functionality, the | Original stream | Original stream | See 8 above | TBC |
| logical effect of which would be to interrupt the | paused or stopped | paused or | | |
| original stream (e.g. in certain embodiments, firing | (TBC) | stopped (TBC) | | |
| up an Internet on TV session or selecting the Alarm | | | | |
| function on the remote control.) | | | | |

### 4. ALLOCATION OF PLAYOUT RESOURCES

The allocation and de-allocation of playout resources is now discussed with reference to FIGS. 1, 2 and 5.

In preferred embodiments, resources used for distribution of content from a HES 2 to LCUs 3 may not be sufficient to enable content to be distributed to all LCUs simultaneously, and thus for all potential users to have access to content at the same time. Typically, such playout resources may be restricted for economic reasons as, although the systems described herein are scaleable and allow all potential users access to content simultaneously if sufficient playout resources are provided, it is unlikely that such demand would arise in most real life situations.

In such preferred embodiments, playout resources are freed automatically when distribution of content to an LCU is paused for a specified period of time, or stopped, and the content is automatically bookmarked, using processes described above. The piayout resources can then be allocated to other LCUs as necessary. If the distribution of the original content is resumed, for instance by the user pressing the pause button or the play button on the remote control unit 23, the bookmark information is retrieved, further playout resources are allocated to the LCU, and distribution of the original content is resumed from the point where it was paused or stopped.

Typically, one or more playout computers are linked to or included in the HES. The playout computers include hard discs 350 on which are stored content available for distribution to users, and playout cards 286 which each control the output of a number of data streams, or output channels 360. The database 340 can be located across the or each hard disc 350, or can be located at a separate storage medium, in which case the or each hard disc stores copies of at least some of the data in the database 340. Typically, the HES sends instructions to a playout computer to stream a particular file, for instance containing a film, to a particular IP address, usually the IP address of a particular LCU. The playout computer is responsible for retrieving the appropriate data from a hard disc 350, and for ensuring that the stream is correctly addressed and played out at the appropriate rate. Typically the stream is passed from an output channel 360 of a playout card to a switch, typically an IGMP switch 170, for onward distribution to the appropriate LCU.

The HES monitors the operation of the playout computer or computers, for instance whether all playout channels are already occupied. Upon receipt of a pause command from a particular LCU, and usually after a certain period, bookmark data is stored at the HES, and the HES instructs the playout computer to make available the particular output channel of a playout card which was streaming data to that LCU. If a request for the distribution of bookmarked content to an LCU to be resumed is received by the HES, the bookmark data is retrieved, and an output channel of a playout computer is assigned to that LCU.

More generally, in the preferred embodiment, playout resources, in the form of playout channels of each of the playout cards, can be allocated, by a control means in the form of a processor, to distribute data to any particular LCU and de-allocated to make them available to distribute data to any LCU as required.

This allocation and de-allocation is performed dynamically, if required.

In one example, in the preferred embodiment, a playout channel is allocated to an LCU by a processor, in the form of the Media Manager 311 component of the HES, in response to a request for data from that LCU, and data is streamed to the LCU via that playout channel. During streaming of the data, the playout channel is de-allocated and another playout channel is allocated to continue the streaming of the data. The allocation and de-allocation of the channels is performed simultaneously so that data is streamed continuously to the LCU, or, in a variant of the preferred embodiment, so that the impression is given to a user that the data is streamed continuously.

In variants of the preferred embodiment, the de-allocation of a playout channel and the allocation of another playout channel does not occur simultaneously. In such case, data is cached during the changeover period, at a memory at the LCU or at the HES, in order to ensure a continuous streaming of data.

A fast playout channel is dynamically replaced, under control of a processor, by a second playout channel in the streaming of data to an LCU, in one example, if the first playout channel becomes inoperable due to a fault.

### 5. REDIRECTION OF REQUESTS FOR DATA

In the preferred embodiment, users are able to access the internet via an Internet-on-TV application or via a portable or other computer connected via an Ethernet port 16 or serial port 18.

Requests for connection to an internet site pass from the LCU to the HES, then through the firewall 7, and are then forwarded to the addressed internet site if they match criteria which are assessed by the firewall and if an internet connection is available.

If, for instance, a requested web page is understood potentially to contain inappropriate content as specified by the firewall 7 under the control of the HES 2, then the request for data is stopped by the firewall, and data is returned to the LCU, for display to a user, stating that the requested web page is unavailable.

Furthermore, if it is not possible to satisfy the request for data, for instance if an internet connection is not available or if a component of the local system is inoperable, then again data is returned to the LCU, for display to a user, stating that the requested data is unavailable.

In the preferred embodiment, the HES, by control of the firewall is able to control the data sent to a user in response to a request for data, for instance interne data, independently of any characteristics of the particular data requested and whether or not the particular data requested is available.

In the preferred embodiment, for instance, whenever an internet session is started then regardless of what internet data is requested by the user, preferred web page data is sent to the LCU. For instance, the hotel's own web page data may sent to the LCU. Subsequent requests for data are then processed normally, and requested data is returned to the user, if available or if allowed.

In this example, the request for data is replaced with a request for the hotel's own web page data.

A processor and a memory are provided at the HES to determine when an internet session is started and to return the preferred data to the LCU upon receipt of the first request for data.

Various other criteria can be specified by the processor to determine how requests for data, particularly internet data, are processed. For instance, a user may be limited to access only certain internet sites unless they have purchased the appropriate billing option, or a user may have to input an identifier and may only be allowed access to particular internet sites in dependence upon this identifier. If they are not allowed access, then requests for data will be replaced with requests for other data independently of the characteristics of the data requested.

### 6. INTERLEAVED CONTENT

Aspects of the system relating to the interleaving of content are now described, in particular, the interleaving of different types of content in transmissions between a HES and an LCU, with references to FIGS. 1, 2 and 3. Various capabilities of the system which derive from the interleaving of content are discussed in more detail, particularly the interleaving of Internet and audio/visual data, and the impression given to a user that at least one apparently continuous stream of data can be delivered in real time simultaneously with the delivery of other data. The interleaving of more than two sets of data and the selective control of one or more interleaved sets of data upon command of a user are also discussed.

A variety of data is transmitted between the HES and an LCU, in particular audio/visual data, particularly digital television/video signals, text data, still images, moving images, EPGs, games, computer data particularly computer programmes or Internet data. In preferred embodiments sets of such data are divided into portions and portions of one set of data are interleaved with portions of another set of data.

The first set of data may be a particular piece of content, for instance a film, and the second set of data may be another piece of content, for instance another film.

The portions of the first data set and the portions of the second data set are usually interleaved temporally within a data stream. Typically, each portion of the first data set is transmitted in a respective one of a first set of packets, and each portion of the second data set is transmitted in a respective one of a second set of packets, the packets usually being IP packets.

Upon receipt at an LCU, the portions of the first set of data are processed to form the first set of data, and the portions of the second set of data are processed to form the second set of data.

The portions of the first set of data and the portions of the second set of data can also be retransmitted to an output device without first being recombined. For instance, in one example, the first set of data is audio/visual data in MPEG format, representing a film, and each packet containing a portion of the first set of data is received by the LCU and then streamed to a television connected to the LCU in real time. The second set of data is internet data, and each packet containing a portion of the second set of data is received at the LCU, and streamed to a computer connected to the LCU.

If the size and contents of the interleaved packets of data are chosen appropriately, by an application at the HES, the impression can be given to the user that at least one continuous stream of data is being received, when in fact two interleaved sets of data are being received.

The LCU, either upon command of a user or automatically is able to control independently the transmission of any of the interleaved sets of data transmitted from the HES to the LCU.

The interleaving of content is particularly advantageous when an LCU is connected to more than one device, as it enables content to be transmitted to, and for the HES to communicate with each device, via the LCU, simultaneously.

An example of the interleaving of content is given in FIG. 12.

A first video asset (VID1) is transmitted to the HES 2 over the satellite link 52,54,56 shown in FIG. 1 and stored by the EMS 2.

A second video asset (VID2) is subsequently transmitted to the HES 2 over the satellite link and stored by the HES 2.

LCU 3 requests that VID1 be played in real time on television set 5, and that VID2 be simultaneously played in real time on laptop 6.

The Media Manager divides VID1 and VID2 into N respective packets of data VID1(1), VID1(2) . . . VID1(N); and VID2(1), VID2(2) . . . VID2(N). The N packets of data are then transmitted in interleaved form VID1(1), VID2(1), VID1(2), VID2(2) etc. Each packet is then received by LCU 3 and directed to either television 5 or laptop 6 as appropriate.

FIG. 13 illustrates the simultaneous output of four videos VID1, VID2 (from TV 5 and Laptop 6 as described above) and VID3 and VID4 (from TV 5′ and Laptop 6′ attached to a different LCU).

VID1 and VID2 are transmitted in interleaved form to a first LCU (designated in FIG. 12 by the label “CHANNEL 1”), and VID3 and VID4 are transmitted in interleaved form to a second LCU (designated in FIG. 12 by the label “CHANNEL 2”).

Preferably each packet of data VID1(1), VID2(1), VID3(1), VID4(1) etc is an IP packet containing an IP address of the correct LCU. Alternatively the signals may be frequency multiplexed and each LCU would have its own dedicated frequency channel.

Although in the example given above, VID1-VID4 are previously received and stored by the HES 2, it will be understood that one or more of the video assets may be received and immediately forwarded (interleaved with another video asset) to an LCU, without an intermediate storage step.

In an alternative embodiment, audio/video signals (for instance VID1(1), VID2(2) . . . VID1(N)) may be interleaved with internet signals, enabling a user to surf the internet using laptop 6 whilst watching a movie on television 5.

In a further embodiment the HES may send an information or error message to the user (for instance, the user may have reached some time limit related to billing) and the transmission of audio/visual data and/or internet signals is interrupted whilst the message is displayed on the television 5 or laptop 6. Upon response of the user to the message, (for instance by sending a signal to the LCU using the remote control unit, in response to which the LCU sends a message to the HES), interruption period is terminated and the transmission of the audio/visual data and/or internet signals is resumed. In a variant of this embodiment, the audio/visual data and internet signals continue to be transmitted along with the message data (ie interleaving of three sets of data), and the audio/visual data and/or internet signals are buffered whilst the message data is displayed.

Although the video assets VID1, VID2 in FIG. 12 are received and retransmitted by the LCU in real-time, it will be understood that different types of interleaved content may be processed, stored or routed in different ways. For instance some packets of data may be combined at the LCU before storage or retransmission to a connected device.

### 7. CAPABILITIES OF SYSTEM

Some capabilities of the preferred embodiment within hotels are now described. The same or similar capabilities also obtain for variants of the preferred embodiment in environments other than hotels.

The system provides up-to-the-minute customised content—by pan-European satellite, with full on-demand programming in multiple languages, and hotel services direct to the guest. One can gain revenue from programmes specially made for a guest, with tailored solutions, based on factors such as guest profile, occupancy rates and room yield.

The system offers new services, upgrading technology and managing content.

All services offered are the result of extensive research into the demands of both guests and hoteliers. All new services are based on ongoing research. The system offers up to the minute customised content specially made for each guest, with designed services to reflect guests' in-room behaviour.

The system is the first to record every instruction on the server.

The system provides a digital ‘jukebox’ for hotel guests. The choice of albums is reviewed and updated regularly to meet guests' demands.

The system also provides a single, secure link to a hotel's property management system. Important added value services have been designed to increase staff productivity and improve guest satisfaction.

The system can pass messages to individual guests, and target information to specific groups of guests, such as informing conference delegates of meeting times and venues.

### 8. ALTERNATIVE EMBODIMENTS

Many of the embodiments as described herein (in any aspect or embodiment) are directed to systems within hotels and then installation and use. However, the embodiments, and the systems, methods and features, described herein are also readily installed and used within other environments, in particular multi-user or multi-room environments. Such environments include, in particular:—
Ships, particularly cruise ships
Aeroplanes
Trains
Hospitals
Multi-dwelling units, for instance blocks of flats, or condominiums
Groups of houses
Offices or groups of offices, factories, shops or groups of shops, schools and other work, commercial or educational environments
Stations, airports and other transport termini

Indeed, one of the features of the preferred embodiments is that they are readily transferable between various environments, such as those described above, with little or no modification.

Accordingly, references to a guest shall be taken to include any user of any such embodiment in any such environment.

A feature of the preferred embodiments is that the signals, data or information which are distributed are not limited to audio/visual, particularly television, signals, data or information, nor are preferred embodiments limited to providing entertainment services.

Indeed preferred embodiments provide general information, messaging services, alarm calls, pricing and billing information, educational material, documents in electronic format, or indeed any type of material which can be stored or transmitted electronically and retrieved or received by a local server.

In particular embodiments, within hospitals, the system is used to provide messaging, alarm calls, and scheduling information to nurses, doctors and other hospital staff. In some such embodiments, local control units, or in the alternative local servers, are linked to pagers carried by staff.

In particular embodiments within schools, colleges, universities and other educational environments, the system is used to provide educational material, such as lecture notes, textbook material, and audio/visual material, and to enable communication between teachers and students, as well as providing general messaging, timetable and information services.

In particular embodiments within groups of houses, the system is used to provide entertainment, such as terrestrial and satellite television, radio, audio, video on demand, scheduled films, and games, educational material such as textbook material, lessons, lecture notes, and audio/visual material, advertising, both general and targeted, banking and other financial services, shopping services, and general information.

In particular embodiments within hotels, ships, trains, aeroplanes, stations, and airports, the system is used to provide, in addition to some of the material and services described above, timetable, ticketing, reservation, weather and other travel related information.

In particular embodiments within offices, factories and other work environments, the system us used to provide, in addition to some of the material and services described above, access to documents in electronic form, recordal of employee attendance, diary and scheduling services, payroll information and services, training material, and logistical information.

The following is applicable to any aspect or embodiment as described herein, or as illustrated in the accompanying drawings.

Features which relate to the storage of information may be implemented by suitable memory locations or stores. Features which relate to the processing of information may be implemented by a suitable processor or control means, either in software or in hardware or in a combination of the two.

Analogous method steps to any of the apparatus features described anywhere herein are provided within the scope of the invention, and vice versa. In any or all of the aforementioned, different features and aspects described above, including method and apparatus features and aspects, may be combined in any appropriate fashion.

The Applicant asserts design right and/or copyright in the accompanying drawings.

It will be understood that the present invention(s) has been described above purely by way of example, and modifications of detail can be made within the scope of the invention.

Each feature disclosed in the description, and (where appropriate) the Claims and drawings may be provided independently or in any appropriate combination.

What is claimed is:

1. An audio/visual content distribution system, comprising:
a local distribution sub-system comprising:
a digital network;
a plurality of receivers, each of which comprises:
an audio/visual display; and
a local control unit to which the audio/visual display is connected, the local control unit comprising:
a main network port having an IP address by which the audio/visual display can be connected to the digital network to receive audio/visual content;
a guest port by which a laptop computer can be connected to the digital network to communicate with the Internet; and
a head-end server adapted to manage distribution of audio/visual content data to the plurality of receivers, the head-end server being connected to the plurality of receivers by the digital network and comprising:
a gateway server for providing a connection between the digital network and the Internet;
at least one data storage device for storing audio/visual content;
a media manager application configured to:
provide a menu for each receiver of stored audio/visual content available for distribution within the local distribution sub-system;
receive requests from the receivers for audio/visual content; and
send requested audio/visual content to the receivers over the digital network in response to requests;
wherein the system is configured to route audio/visual content data and Internet data from the head end server via the digital network to the local control units, and to direct audio/visual content data to the main network port of a respective local control unit, and Internet data to one of the main network port and the guest port of the respective local control unit.

2. An audio/visual content distribution system as claimed in claim 1, wherein the head end server is configured to provide an IP address for the guest port of each local control unit, and an IP address to assign to a laptop computer connected to the guest port.

3. An audio/visual content distribution system as claimed in claim 2, wherein the laptop computer connected to the guest port has a DHCP client, and the local control unit is configured to:
provide a netmask which describes the IP address for the guest port and the IP address to assign to the laptop computer as being on a same subnet while providing differentiation from the IP address of the main network port of the respective local control unit; and
provide to the laptop computer, in response to a request for a DHCP server broadcast by the laptop to the guest port, the assigned IP address, a DNS server setting, and identification of the local control unit as the default gateway.

4. An audio/visual content distribution system as claimed in claim 1, wherein the main network port and the guest port of each local control unit is an Ethernet port.

5. An audio/visual content distribution system as claimed in claim 1, wherein each receiver further comprises a separate remote control device adapted to control the audio/visual display; and wherein a respective local control unit is configured to receive signal inputs from the separate remote control device.

6. An audio/visual content distribution system as claimed in claim 1, wherein the main network port of each local control unit is configured to provide an Internet connection for the audio/visual display.

7. An audio/visual content distribution system as claimed in claim 1, wherein the local distribution sub-system is configured to provide audio/visual content to rooms in a hotel; and wherein the head-end server is located in the hotel and the audio/visual display of each of the plurality of receivers comprises a television located in a respective room in the hotel.

8. An audio/visual content distribution system as claimed in claim 7, wherein the receiver is configured to receive instructions from a user via at least one of the local control unit and the television, and the head-end server is configured to record the instructions.

9. An audio/visual content distribution system as claimed in claim 1, further comprising a firewall configured to connect the local distribution sub-system to the Internet, wherein the gateway server is configured to:
control and monitor connections between a laptop computer connected to a local control unit and the firewall;
ensure that data packages are routed securely to respective inbound and outbound destinations;
manage Internet connection sessions;
monitor Internet data traffic flows; and
collect statistics relating to Internet usage.

10. A method of distributing audio/visual content distribution, comprising:
providing a local distribution sub-system comprising:
a digital network;
a plurality of receivers, each of which comprises:
an audio/visual display; and
a local control unit to which the audio/visual display is connected, the local control unit comprising:
a main network port having an IP address by which the audio/visual display can be connected to the digital network to receive audio/visual content;
a guest port by which a laptop computer can be connected to the digital network to communicate with the Internet; and
a head-end server adapted to manage distribution of audio/visual content data to the plurality of receivers, the head-end server being connected to the plurality of receivers by the digital network and comprising:
a gateway server for providing a connection between the digital network and the Internet;
at least one data storage device for storing audio/visual content;
a media manager application configured to:
provide a menu for each receiver of stored audio/visual content available for distribution within the local distribution sub-system;
receive requests from the receivers for audio/visual content; and
send requested audio/visual content to the receivers over the digital network in response to requests;
routing audio/visual content data and Internet data from the head end server via the digital network to the local control units; and
directing audio/visual content data to the main network port of a respective local control unit, and Internet data to one of the main network port and the guest port of the respective local control unit.

11. A method as claimed in claim 10, further comprising providing, by means of the head end server, an IP address for the guest port of each local control unit and an IP address to assign to a laptop computer connected to the guest port.

12. A method as claimed in claim 11, further comprising:
connecting the laptop computer connected to the guest port, the laptop computer having a DHCP client;
providing, by means of the local control unit, a netmask which describes the IP address for the guest port and the IP address to assign to the laptop computer as being on a same subnet while providing differentiation from the IP address of the main network port of the respective local control unit; and
providing from the local control unit to the laptop computer, in response to a request for a DHCP server broadcast by the laptop to the guest port, the assigned IP address, a DNS server setting, and identification of the local control unit as the default gateway.

13. A method as claimed in claim 10, further comprising converting digital audio/visual content data to analog data in the local control unit before passing the analog data to the display.

14. A method as claimed in claim 10, further comprising:
routing data from a laptop computer connected to the guest port from the local control unit to the gateway server; and
routing data destined for the laptop computer through the guest port of the local control unit.

15. A method as claimed in claim 10, further comprising using the local control unit for access to Internet services via the display device.

16. An audio/visual content distribution system, comprising:
a local distribution sub-system comprising:
a digital network;
a plurality of receivers, each of which comprises:
an audio/visual display; and
a local control unit to which the audio/visual display is connected, the local control unit comprising:
a main network port having an TP address by which the audio/visual display can be connected to the digital network to receive audio/visual content;
a guest port by which a laptop computer can be connected to the digital network to communicate with the Internet; and
a head-end server adapted to manage distribution of audio/visual content data to the plurality of receivers, the head-end server being connected to the plurality of receivers by the digital network and comprising:
a gateway server for providing a connection between the digital network and the Internet;
at least one data storage device for storing audio/visual content;
a media manager application configured to:
provide a menu for each receiver of stored audio/visual content available for distribution within the local distribution sub-system;
receive requests from the receivers for audio/visual content; and
send requested audio/visual content to the receivers over the digital network in response to requests;
wherein the system is configured to:
route audio/visual content data and Internet data from the head end server via the digital network to the local control units;
direct audio/visual content data to the main network port of a respective local control unit, and Internet data to one of the main network port and the guest port of the respective local control unit; and
provide an IP address for the guest port of each local control unit, and an P address to assign to a laptop computer connected to the guest port;
and wherein, when a laptop computer connected to the guest port has a DHCP client, the local control unit is configured to:
provide a netmask which describes the IP address for the guest port and the IP address to assign to the laptop computer as being on a same subnet while providing differentiation from the IP address of the main network port of the respective local control unit; and
provide to the laptop computer, in response to a request for a DHCP server broadcast by the laptop to the guest port, the assigned IP address, a DNS server setting, and identification of the local control unit as the default gateway.

17. An audio/visual content distribution system as claimed in claim 16, wherein each receiver further comprises a separate remote control device adapted to control the audio/visual display; and wherein a respective local control unit is configured to receive signal inputs from the separate remote control device.

18. An audio/visual content distribution system as claimed in claim 16, wherein the main network port of each local control unit is configured to provide an Internet connection for the audio/visual display.

19. An audio/visual content distribution system as claimed in claim 16, wherein:
the local distribution sub-system is configured to provide audio/visual content to rooms in a hotel;
the head-end server is located in the hotel and the audio/visual display of each of the plurality of receivers comprises a television located in a respective room in the hotel; and
the receiver is configured to receive instructions from a user via at least one of the local control unit and the television, and the head-end server is configured to record the instructions.

20. An audio/visual content distribution system as claimed in claim 16, further comprising a firewall configured to connect the local distribution sub-system to the Internet, wherein the gateway server is configured to:
control and monitor connections between a laptop computer connected to a local control unit and the firewall;
ensure that data packages are routed securely to respective inbound and outbound destinations;
manage Internet connection sessions;
monitor Internet data traffic flows; and
collect statistics relating to Internet usage.
